(19) United States
(12) Patent Application Publication
(10) Pub. No.: US 2007/0011083 A1
(43) Pub. Date: Jan. 11, 2007

(54) System and method of processing asset financing transactions

(76) Inventors: Alan H. Bird, Pickering (CA); Michael A. Collins, Toronto (CA); Desmond M. Reynolds, Burlington (CA); Kreig C. Smith, Overland Park, KS (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/178,040

(22) Filed: Jul. 8, 2005

(51) Int. Cl. G06Q 40/00

(52) U.S. Cl. 705/38

(57) ABSTRACT

A computer system processes asset financing transactions. An applicant provides loan information related to financing of an asset. A single lender is selected to receive a loan package based on the loan information and knowledge and prior experience attributed to the single lender. A plurality of data entry screens are configured to requirements of the single lender. The loan information is entered into fields of the data entry screens. The loan information is validated upon entry. The loan package from the loan information is compiled for submission to the single lender. The loan package may be pre-approved by the dealer prior to submission to the single lender. The system further provides for status request of loan applications based on search criteria, requesting credit reports of applicant, and electronic messaging with the single lender.

### FIELD OF THE INVENTION

The present invention relates in general to financing transactions and, more particularly, to a system and method of processing financing transactions of major asset purchases.

### BACKGROUND OF THE INVENTION

Consumers and businesses routinely purchase or lease big ticket or major assets for business, personal use, pleasure, and investment. The assets include such items as autos, trucks, marine, RVs, aircraft, motorcycles, and off-road vehicles. In many purchasing situations, the buyer does not necessarily have the funds on hand to complete the transaction. In other cases, the buyer may not want to use limited available funds to pay for the asset. In such cases, the asset purchase or lease is commonly completed through a loan or financing transaction.

The buyer or consumer wanting to purchase the asset usually works with the seller of the asset to arrange for financing. Alternatively, the buyer contacts the funding institution directly to make arrangements for the loan. The typical financing transaction involves a substantial amount of paperwork and confirmation of records to finalize the deal. The purchaser wants to complete the loan application with the least effort and still receive a competitive financing package. The lending institution wants to confirm that the buyer is credit worthy and to have assurances that the loan will be repaid and in the final analysis earn a profit. The dealer wants to complete the sale.

In purchasing or leasing the major asset, the asset purchase and corresponding financing is often arranged through a dealer or broker. The dealer may be a national auto dealership, third party broker, or other seller of major assets. The dealer wants to complete the purchase transaction and does so by helping the purchaser obtain the necessary financing. Even though the dealer works with various financing transactions on a routine basis through a process of indirect financing, consumers still spend considerable time applying for and awaiting a decision on the loan. Consumers usually dislike the financing portion of the deal; dealers fear losing the sale if the loan comes back with problems; time is money for all concerned. Consumers and dealers alike want to minimize the effort, reduce the time, and ease the process of getting the loan approved.

In one example of the process of applying for indirect financing, once the parties successfully negotiate the model, options, and pricing of the unit, the consumer visits the dealer's financing office. In other situations, the financing aspects are addressed first to confirm the credit worthiness of the consumer before putting forth any effort into the product selection and negotiation. The dealer completes a financing application using the consumer's personal information which is entered into a computer system. The computer prints out the paperwork which is faxed to the bank, credit union, credit company, or other financing institution. The lender reviews the application and returns a decision to the dealer. The process may take several hours to complete. If the loan application is rejected, the dealer has to determine the problem and attempt to resolve it. Otherwise, the process may need to begin again with another lender, assuming the consumer has not lost interest and given up.

To help the consumer, dealer, and lender alike, a number of computer programs and software applications have been developed to aid in the loan approval process. Some examples of such efforts are disclosed in U.S. Pat. No. 5,878,403 entitled “Computer Implemented Automated Credit Application Analysis and Decision Routing System”; and U.S. Pat. No. 6,587,841 entitled “Computer Implemented Automated Credit Application Analysis and Decision Routing System”. In general, these patents discuss the principal of transmitting a loan application to multiple lenders by computer controlled communication systems. The dealer collects consumer information. The loan data is transferred to the lender and, in some cases, to a credit bureau. In an effort to speed up the processing, the consumer loan information is transmitted to several financing institutions simultaneously or in close succession. The dealer then waits to see which lender responds first or which one has the best loan deal. This common practice is known as shotgunning. The object of shotgunning is to have several financial institutions consider the application simultaneously, or in a temporal close serial fashion, in order to maximize the chances of a positive decision from somebody.

Unfortunately, the practice of shotgunning has the effect of forcing the financial institutions to spend considerable time and effort reviewing and making decisions about loan applications that often do not result in real financing deals at the end of the day. In reality, shotgunning reduces loan processing efficiency because the process dramatically multiplies the number of loan applications far in excess of the actual number of assets being purchased. If the dealer shotguns one actual asset purchase into say five loan applications, then at least four of the lenders are wasting time in processing loan applications that will never come to pass. The shotgun approach increases loan processing costs and time, which ultimately are passed to the consumer.

The above-mentioned patents also tout an automated loan application process of sequentially transmitting consumer data to a number of lenders from a pre-defined list and then awaiting a reply. If one lender responds in the negative, or takes too long to respond, then the consumer loan data is automatically sent to the next lender in sequence on the list. The process of automatically sending consumer loan data to each name on a pre-defined list of several lenders in a sequential manner until one responds in the positive is also relatively slow and burdensome to all parties concerned. It is merely a variation of shotgunning which reduces loan processing efficiency and increases loan processing costs as described above.

Another U.S. Pat. No. 6,208,979 entitled “Computer-driven Information Management System for Selectively Matching Credit Applicants with Money Lenders through a Global Communications Network” considers creation of a computer model of lender-defined, desirable applicant characteristics. The individual applicant loan data is electronically compared to the computer models of multiple financing institutions to identify which lenders will likely approve the loan.

In any event, these automated loan processing programs do not solve many of the problems still facing consumers, dealers, and lenders. For example, many application forms are lengthy and convoluted. Different financial institutions have different requirements for information in order to come to a financing decision. The lender's financing forms are known to promote data entry errors. In many cases, the forms as submitted to lenders are rejected on technical grounds because the information provided by the preparer is illegible, incomplete, inconsistent, or incorrect. Such problems cause delays in the credit approval process, as the lender may be required to go back to the dealer for further information or clarification.

In other cases, the consumer or dealer completing the forms may not fully understand all sections of the form. The forms may be written and formatted to cover all possible permutations of the applicant, which can cause confusion. For instance, there may be space for filling-in information with respect to co-applicants, which is not applicable to all transactions. The one form fits all approach requires the preparer to carefully review all portions of the form to determine if all required information is present and accurate.

Another cause of time delay and potential errors is in the document generation stage of the asset financing process. In order to receive funding from the financial institution, the dealer must prepare and print detailed loan or lease contracts for execution by the customer. Each lender may have different document requirements so the contracts are often created by re-typing the customer information and other relevant parts of the transaction gathered at the application stage into loan or lease contracts and other documentation. The document preparation process takes time to re-enter manually and introduces further opportunity for errors, miscalculations, and missing or extraneous information. Finance contracts are typically complex and may be ill-understood by staff preparing the documents. In certain cases, a deal may be lost due to problems with the transaction documentation.

### SUMMARY OF THE INVENTION

In one embodiment, the present invention is a computer implemented method of processing asset financing transactions comprising providing for selection of a single financial institution to receive a financing package, providing a plurality of data entry screens configured to requirements of the single financial institution for entry of financing information, and compiling the financing package from the financing information for submission to the single financial institution.

In another embodiment, the present invention is a method of processing asset financing transactions through a dealer comprising providing for selection of a single lender to receive a financing package, providing a data entry screen for entering financing information into fields of the data entry screen, compiling the financing package from the financing information entered into the fields of the data entry screen, and providing for pre-approval of the loan package prior to submission to the single lender

In another embodiment, the present invention is a method of processing asset financing transactions comprising providing a process for receiving financing information related to financing of an asset, providing for selection of a single financial institution to receive a financing package compiled from the financing information, and transmitting the financing package to the single financial institution.

In another embodiment, the present invention is a method of processing asset financing transactions comprising providing a process for receiving loan information related to financing of an asset, wherein the process includes a data entry screen configurable to receive multiple forms of collateral information, providing for selection of a single financial institution to receive a financing package compiled from the financing information, and transmitting the financing package to the single financial institution.

In another embodiment, the present invention is a computer program product usable with a programmable computer processor having a computer readable program code embodied therein. The computer readable program code receives financing information related to financing of an asset, provides for selection of a single financial institution to receive a financing package, provides for entry of financing information into fields of a data entry screen, and compiles the financing package from the financing information for submission to the single financial institution.

In another embodiment, the present invention is a computer system for processing asset financing transactions comprising means for receiving loan information related to financing of an asset, means for selecting a single lender to receive a loan package, means for providing a data entry screen for entering the loan information into fields of the data entry screen, and means for compiling the loan package from the loan information for submission to the single lender.

### BRIEF DESCRIPTION OF THE DRAWINGS

FIG. 1 illustrates a simplified structure and flow of the asset financing modules;

FIG. 2 illustrates a general computer system for executing the asset financing system;

FIG. 3 illustrates a computer communication network for processing financing transactions;

FIG. 4 is the main menu for the asset financing system;

FIG. 5 illustrates the lender selection portion of creating a loan application within the asset financing system;

FIG. 6 illustrates a credit bureau report;

FIG. 7 illustrates an application folder for displaying contents and status of the loan application;

FIG. 8 illustrates a recreational vehicle collateral description data entry screen;

FIG. 9 represents a marine collateral description data entry screen;

FIGS. 10a-10b illustrate book-out sheets for use with marine and RV collateral data entry screens;

FIG. 11 illustrates a power sports collateral description data entry screen;

FIG. 12 illustrates a loan submission worksheet for submitting loan information;

FIG. 13 illustrates application messages for sending and receiving electronic messages;

FIG. 14 illustrates a status list for requesting and viewing status of the application folders;

FIG. 15 illustrates a copy screen for copying the contents of an application folder to another application folder;

FIG. 16 illustrates a lender center for providing useful features within the asset financing system about lenders or lender programs for dealers;

FIGS. 17a-17b illustrate a flowchart of the dealer signup process to use the asset financing system;

FIGS. 18a-18b illustrate a flowchart of the dealer setup process to use the asset financing system;

FIGS. 19a-19b illustrate a flowchart of dealer groups;

FIGS. 20a-20b illustrate a flowchart of the user setup process to use the asset financing system;

FIGS. 21a-21b illustrate a flowchart of the lender center process;

FIGS. 22a-22b illustrate a flowchart of the comments box entry process;

FIGS. 23a-23b illustrate a flowchart of the user log-in process;

FIGS. 24a-24b illustrate a flowchart of the application creation process;

FIGS. 25a-25b illustrate a flowchart of the quick bureau process;

FIGS. 26a-26b illustrate a flowchart of the applicant/co-applicant entry process;

FIG. 27 illustrates a flowchart of the credit bureau process;

FIGS. 28a-28b illustrate a flowchart of the collateral entry process;

FIGS. 29a-29b illustrate a flowchart of the loan submission worksheet process;

FIGS. 30a-30b illustrate a flowchart of the applicant submission and decision process;

FIGS. 31a-31b illustrate a flowchart of the application approved process;

FIGS. 32a-32b illustrate a flowchart of the lender self administration related to users and dealers; and

FIGS. 33a-33b illustrate a flowchart of the lender self administration related to table and document management.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Lenders are in the business of loaning money. The lender can be considered as anyone providing financing for asset transactions, both for loan and leases, e.g., banks and credit unions, manufacturer-related financing companies, financial institutions, and other credit-granting institutions. The lender or financial institution can make loans for direct purchases or arrange for lease financing. Consumers often find themselves in the position of needing or wanting to make a major asset purchase, but without the funds on hand to complete the purchase. Dealers are in the business of selling merchandise or assets to consumers, and in doing so work with lenders and consumers alike. The dealer can be considered as anyone directly involved with selling or leasing the asset to the consumer, e.g., commercial dealership, third party brokers, and manufacturers. The major asset purchase includes such items as autos, trucks, marine, recreational vehicles (RV), aircraft, motorcycles, off-road vehicles, consumer goods, real estate, contract rights, intangible property rights, home furnishings, home improvement, office equipment, inventory, manufacturing equipment, livestock, farm equipment, just to name a few. The asset transaction may be a direct purchase or lease. Dealers market to consumers based on year, model, features, and options of the asset. As part of the package, the dealer often helps the consumer arrange for financing to complete the asset transaction. The asset finance transaction involves the process of negotiation, approval, and settlement of terms for financing of the customer selected asset.

In the present invention, a computer implemented asset financing system is provided for the benefit of the dealer, lender, and consumer alike. The asset financing system is “lender-centric” as the system reduces the dependence on standard application forms, allowing lender-specific priorities to be emphasized in the form and amount of data required in an automated application to get credit approval. Dealers and lenders have the opportunity to distinguish themselves in the market for major asset financing. Furthermore, lender-specific documents are generated, facilitating the rapid approval of deals.

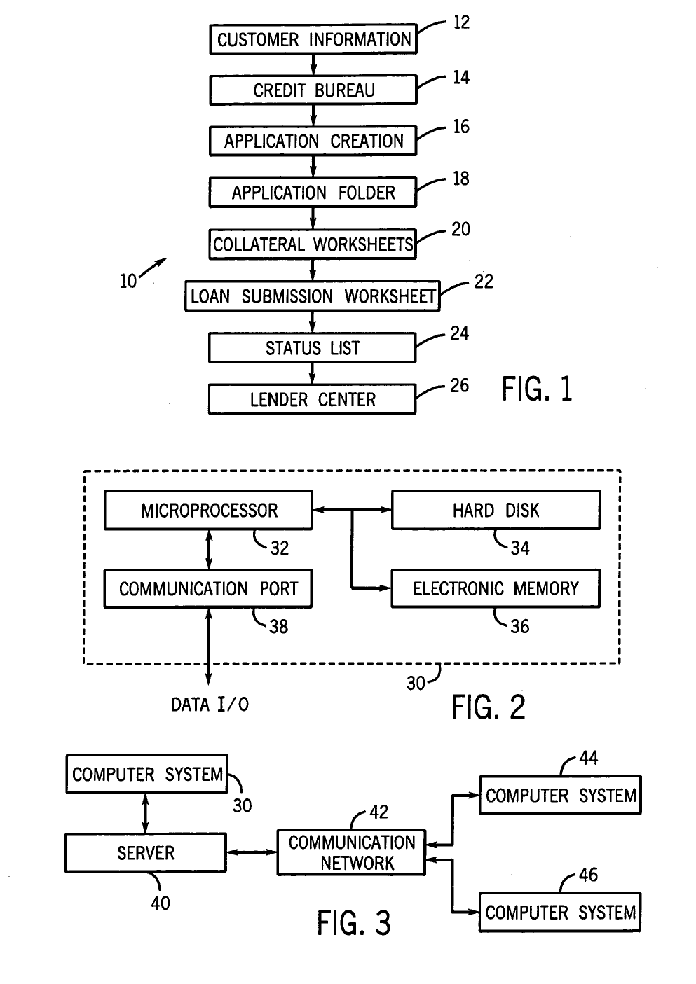

Referring to FIG. 1, asset financing system 10 is shown having multiple components or modules. Customer information module 12 gathers information related to the customer and loan request. Credit bureau module 14 accesses the customer's credit report from an independent credit reporting service. Application creation module 16 provides data entry screens for selecting the lender and entering the applicant's loan information. The loan information is compiled into a loan package for submission to the selected lender. Application folder module 18 displays the contents and pending actions necessary for a given loan application. Collateral worksheet module 20 provides customized data entry screens based on type of collateral offered for the loan. Loan submission module 22 provides for entry of financing data related to the loan. Status list module 24 receives status requests based on selectable search criteria and generates a status report of loan applications. Lender center module 26 provides a forum for dealers and lenders to connect and communicate regarding news, information, programs being offered by the lender. The lender center module 26 also provides a mechanism for the dealer signup with specific lenders and/or change their level of service and status.

In one embodiment, the above system and process can be implemented as one or more software applications or computer programs residing and operating on a computer system. The computer system may be a stand-alone unit or part of a distributed computer network. The computer is typically electronically interconnected with other computers using communication links such as Ethernet, radio frequency (RF), satellite, telephone lines, optical, digital subscriber line, cable connection, wireless, and other recognized communication standards. The electronic connection link between computers can be made through an open architecture system such as the World Wide Web, commonly known as the Internet. The Internet offers a significant capability to share information, data, and software.

FIG. 2 illustrates a simplified computer system 30 for executing the software program used in processing the asset financing transaction. Computer system 30 is a general purpose computer including a central processing unit or microprocessor 32, mass storage device or hard disk 34, electronic memory 36, and communication port 38. Communication port 38 represents a modem, high-speed Ethernet link, or other electronic connection to transmit and receive input/output (I/O) data with respect to other computer systems.

In FIG. 3, computer 30 is shown connected to server 40 by way of communication port 38, which in turn is connected to communication network 42. Server 40 operates as a system controller and includes mass storage devices, operating system, and communication links for interfacing with communication network 42. Communication network 42 can be a local and secure communication network such as an Ethernet network, global secure network, or open architecture such as the Internet. Computer systems 44 and 46 can be configured as shown for computer 30 or dedicated and secure data terminals. Computers 44 and 46 are also connected to communication network 42. Computers 30, 44, and 46 transmit and receive information and data over communication network 42.

Computers 30, 44, and 46 can be physically located in any location with access to a modem or communication link to network 42. For example, computer 30 can be located in the host service provider's main office. Computer 44 can be located in the dealer's main office. Computer 46 can be located in the lender's main office. Alternatively, the computers can be mobile and follow the users to any convenient location, e.g., remote offices, customer locations, hotel rooms, residences, vehicles, public places, or other locale with electronic access to communication network 42.

Each of the computers run application software and computer programs, which can be used to display user interface screens, execute the functionality, and provide the features as described hereinafter. In one embodiment, the screens and functionality are provided on one or more websites or portals on the Internet. The websites are generally restricted access and require passwords or other authorization for accessibility. Communications through the website may be encrypted using secure encryption algorithms. Alternatively, the following screens are accessible only on the secure private network, such as Virtual Private Network (VPN), with proper authorization.

The software can be originally provided on computer readable media, such as compact disks (CDs), magnetic tape, or other mass storage medium. Alternatively, the software can be downloaded from electronic links such as to the host or vendor website. The software is installed onto the computer system hard drive 34 and/or electronic memory 36, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. The software contains one or more programming modules, subroutines, computer links, and compilation of executable code which performs the functionality of the asset financing process. The user interacts with the software via keyboard, mouse, voice recognition, and other user interface devices to the computer system.

The software stores information and data generated during the asset financing process in a database or file structure located on any one of, or combination of, hard drives 34 of the computers 30, 44, 46, and/or server 40. More generally, the information generated during the financing process can be stored on any mass storage device accessible to the computers 30, 44, 46, and/or server 40. The mass storage device for storing the financing information may be part of a distributed computer system.

In the case of Internet-based websites, the interface screens are implemented as one or more webpages for receiving, viewing, and transmitting information related to the asset financing process. For example, the webpages can be set up on computer 30 or server 40 in the host service provider's home office. The dealer accesses the webpages from computer 44 via communication network 42. The screens can also be set up for the dealer on computer 44. If so desired, the lender may access the webpages from computer 46 via communication network 42.

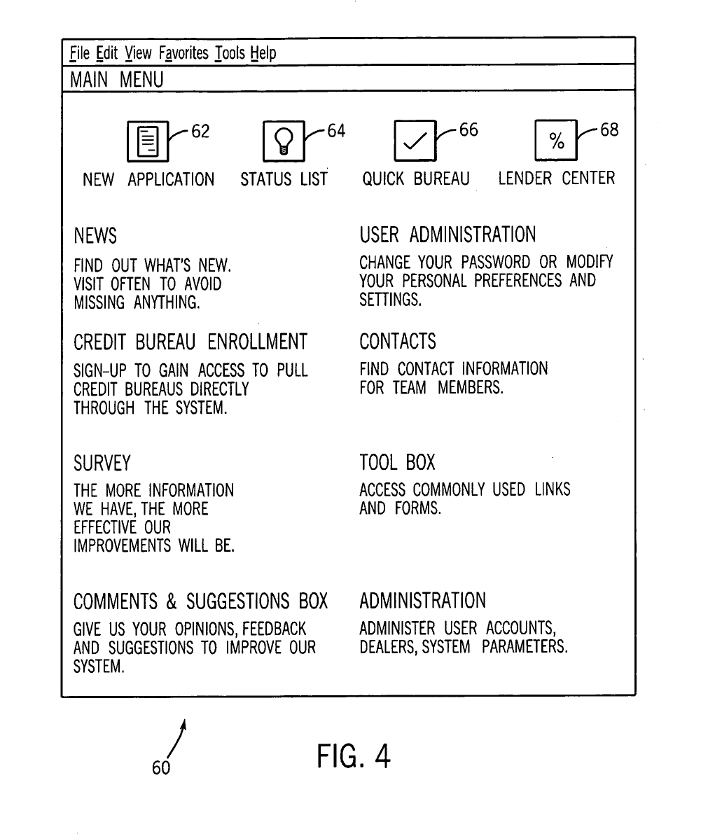

For the purpose of the following illustration, the webpages for displaying the data entry and interface screens and exchange of information are provided on server 40. FIGS. 4-16 illustrate a few of the types of webpages, data entry screens, selections, and information that can be made available on the asset financing process website. An actual commercial website will include more in the way of additional webpages, data entry screens, help screens, functional options, graphics, drawings, text, instructions, marketing, color, and appeal.

The hierarchical structure of the financing processing website is organized by design choice. The organization and design of the website can take many forms and hierarchical structures. Some website designs pack as much information and as many hyperlinks as possible into the first webpage. Other website designs have a first webpage that is clean and simple and count on the user providing some preliminary information before moving to lower level webpages.

The following discussion involves a simplified definition and execution of asset financing system 10 for ease of explanation and understanding. It is understood that asset financing system 10 can be used for more complex, intricate, interactive, and customized transactions.

Asset financing system 10 is controlled by a host or service provider which operates the website or portals for the users' benefit and convenience. The host is responsible for configuration, service, updates, improvements, and generally maintaining the website. The user or participant is understood to be the dealer, lender, consumer, or system administrator, depending on the activity involved.

Website or portal participants in asset financing system 10 are typically registered in advance with the host, as described in further detail below. The registration process may take place online or in person. Registration involves the acceptance of legal terms and conditions. The portal participants provide their contact and billing information, and information on the types of assets and collateral being handled. The participants in the website, i.e., those persons and organizations authorized by the host to access and use the website, are assigned user ids, passwords, and instructions regarding to the operation of asset financing system 10.

In the registration process, the host records unique personal settings for each user or participant. For example, the portal participant may be asked to specify one or more lenders with whom they have or would like to have a business relationship. The relationship may be validated against data provided by the named lender(s) to confirm mutual consent. The user may identify the credit bureau(s) which they subscribe to or would like to use. The system stores which lender(s) and credit bureau(s) are enabled for each specific user. The user may specify types of loans and types of collateral approved for use in their financing transactions. The system permits user organizations to specify permission levels to differentiate between low level users in the organization, who may be entitled only to enter data, and high level users, who may have full permission to submit applications and receive decisions. The user's personal settings are stored in the database on server 40.

The webpages or data entry screens described herein utilize a common user interface, such as may be found in a Windows environment, including title bar, selectable function bar (File, Edit, View, Insert, Format, Tools, Report, Help) with pull down selections and options, tool bars, and main body. The main body displays financing related information for the benefit of the user.

Webpage or data entry screen 60 shown in FIG. 4 illustrates a main menu for user interface activities and selection of specific loan processing steps. Webpage 60 gives the user the option of selecting links to new application 62, status list 64, quick bureau 66, and lender center 68. Webpage 60 also provides electronic hyperlinks to other useful features such as news, credit bureau enrollment, surveys, comments and suggestion box, user administration, contacts, tool box, and administration as described in the figure.

Assume for the present example that the consumer visits a dealership, selects an item for purchase, e.g., automobile, RV, boat, etc., with the desired options, negotiates pricing, and requests financing assistance from the dealer. The customer is directed to the financing department of the dealership. The customer works with the dealership's financing representative to arrange the loan or lease for the item purchased. In this case, the loan will be secured by the item being purchased or leased.

To start the asset financing transaction, the dealer logs into asset financing system 10 using their user id and password. The system recalls the dealer's authorization and personal settings from the database on server 40.

One of the early steps in the asset financing transaction is the selection of a single lender or financial institution to process the loan or lease transaction. Much of the loan processing and presentation of the webpages as described hereinafter is lender specific. The apriori knowledge of the selected lender is necessary to establish the point of reference for subsequent presentation of the webpages and processing of the loan during the asset transaction process. A credit check can be performed first to aid in the selection of the lender.

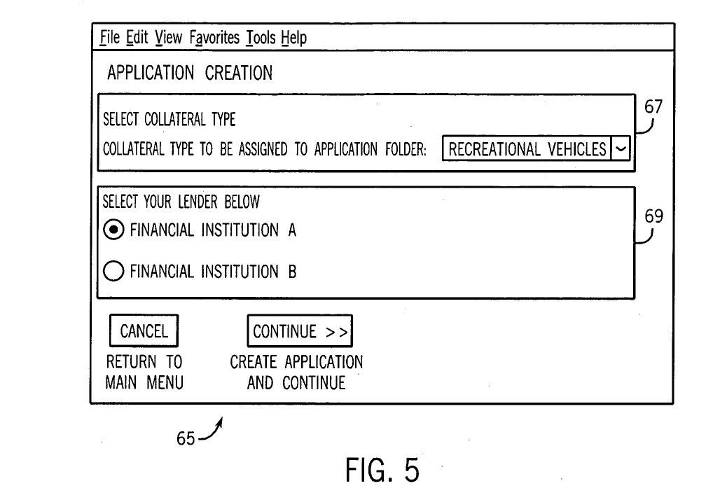

FIG. 5 illustrates webpage 65 for selection of the lender or financing institution. Block 67 provides for selection of the collateral type, which is discussed further below. Block 69 provides for selection of the lender or financing institution. The dealer can select financial institution A or financial institution B by clicking on the circle adjacent to the name. In the present embodiment, the selection of the lender is a prerequisite for further processing of the loan application.

In one aspect, the dealer is working on behalf of the customer trying to get financing approval to complete the sales or leasing transaction. The dealer learns over time the loan criteria, approval threshold, preferences, and idiosyncrasies of each lender, i.e., which deals are prime or non-prime for approval. A non-prime loan request is typically not successful with a lender oriented toward prime deals. A prime loan may not get the best terms from a lender specializing in non-prime loans. The dealer selects a lender that is likely to approve the loan request and still provide the best terms and conditions for the consumer. Based on their experience working with one or more lenders, and with a full understanding of the criteria each lender uses for evaluating loans, the dealer considers objective factors such as applicant(s) age, domicile, credit profile, income, employment history, indebtedness, net worth, collections, account history, bankruptcy, legal actions, auto purchased, collateral, down payment, and objective attributes of the lender.

One of the valued-added features of asset financing system 10 is that the system gives the dealer the ability to select the best lender for the customer, based in part on their knowledge and experience with the lender, as well as the credit worthiness of the applicant and other objective factors listed above. The dealer also considers subjective factors such as historical dealings with the lender and customer convenience or preference. The dealer can make intelligent decisions on selecting the one single lender which is believed to provide the customer with the best combination of (1) likelihood of approval based on the above objective factors, (2) customer service, (3) special lender promotional offers, (4) attractive loan terms including interest rate, down payment, length of loan, and overall service, and (5) other present and prior business dealings between the dealer and lender. The dealer's objective in using asset financing system 10 is to make one single loan request to one single lender. The lender benefits because the deal is real and likely to result in a profitable loan if approval can be confirmed. The customer benefits by making only one loan request to one single lender likely to approve the financing transaction and avoiding having to repeat the application process. The dealer benefits by completing the sale and providing exceptional customer service.

The dealer collects basic information from the customer including name, alias, address, social security number (SSN), phone number, email address, date of birth, place of birth, employer, occupation, income, monthly expenses, and outstanding debt, which is entered into fields of a webpage or data entry screen (not shown) of the computer system. Asset financing system 10 performs validity checking on the data for one or more of the data entry fields. The system confirms the content, value range, and format on a real-time basis as the data is entered by the dealer. For example, the system check for first and last name, properly formatted phone number and email address, valid SSN, zip code matching city and state, and so on. The consumer information is automatically populated in many of the following webpages.

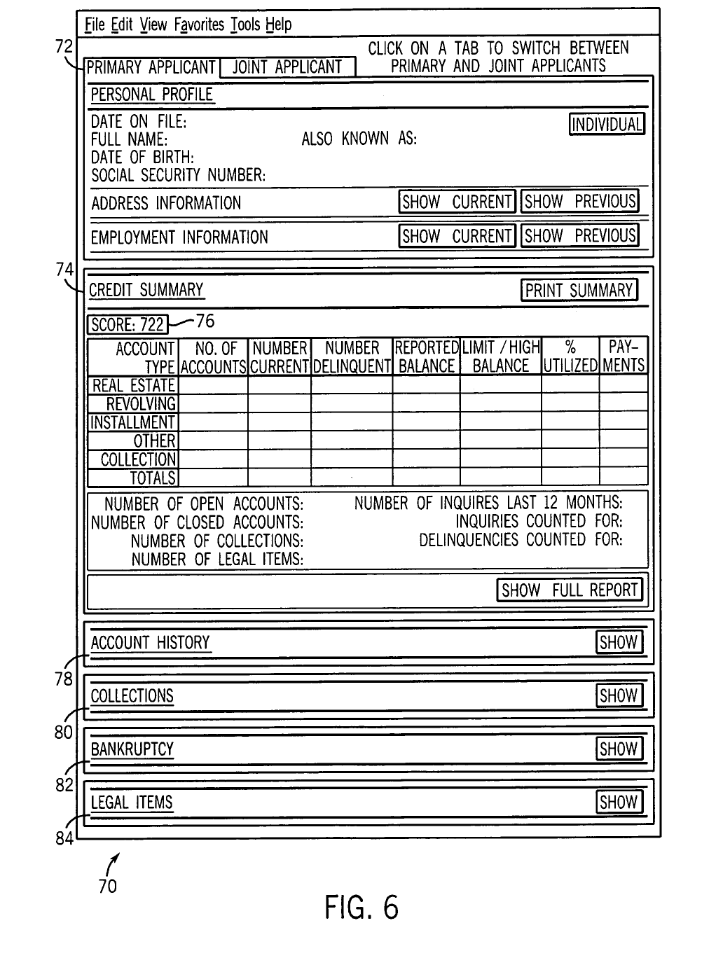

A credit check of the consumer may also be performed for the loan approval process. The system displays the credit bureau(s) which are enabled for the logged-in user. The dealer selects one or more credit reporting bureaus to run the credit check. The consumer information is transmitted to the selected credit bureau(s), which track consumer financial and credit history. In FIG. 6, webpage 70 illustrates a simplified format of an exemplary credit bureau report returned from the credit bureau. Webpage 70 shows the consumer's personal information in block 72, credit history in block 74 (including the all important beacon or credit score in field 76), account history in block 78, collections in block 80, bankruptcy in block 82, and legal items in block 84. The actual credit report will have values in applicable fields of blocks 72-84. The credit report shown in webpage 70 provides useful information, including the beacon or credit score, which can be used by the dealer in determining which one of several lenders is likely to approve the consumer's loan request. The credit report is stored on the database on server 40 and may be sent to the lender as part of the loan package in the normal course of the loan process or by specific request.

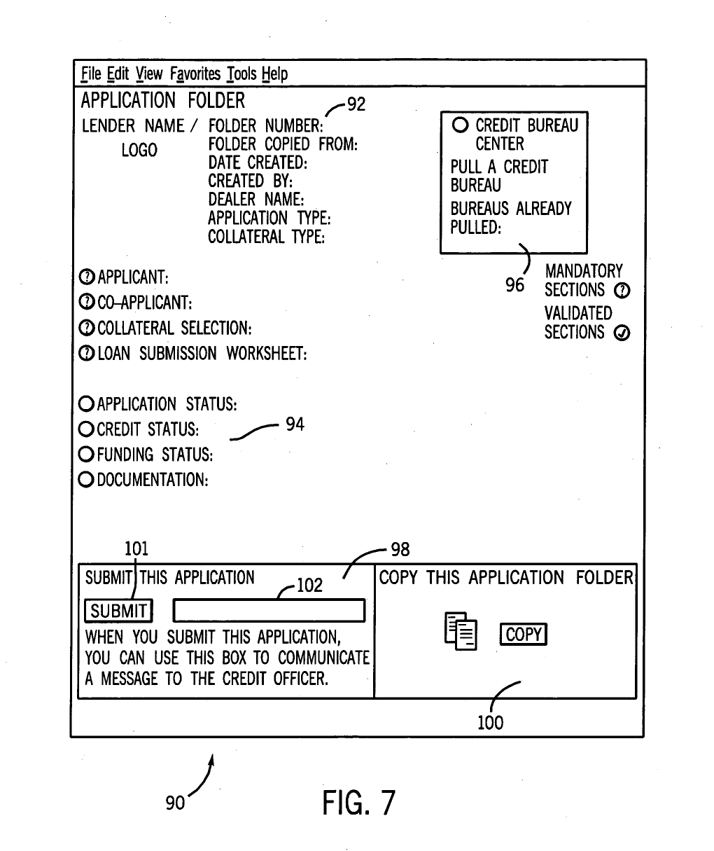

Using the customer's loan information and overall personal profile, the dealer opens an application folder on asset financing system 10 for the one selected lender. An application folder 90 is shown in FIG. 7. The application folder 90 is lender specific. That is, each lender has certain information fields, formats, and validation checks that need to be done for a complete loan application, which is compliant with the rules established by the single selected lender. For example, each lender may have different information displayed in block 92. Each lender can specify what fields are displayed in block 94, when each field appears, and what loan processing requirements are associated with each field. Some lenders may have credit information displayed in block 96; other lenders may eliminate block 96 entirely. In general, all fields and information displayed and processed in application folder 90 are dynamically configurable for each lender's rules and preferences. Asset financing system 10 will control the contents and operation of the application folder and overall loan processing according to the selected lender's requirements as defined in the database on server 40. The lender's name and/or logo are displayed on the application folder 90 and lower data entry screens or webpages accessible from the application folder as a reminder of the target loan being processed. Any validation checking is also done based on the lender's requirements.

The application folder 90 presents information such as folder number, date created, dealer name, application type, and collateral in block 92. The application folder tracks whether the application is complete and ready for submission to the lender. Each lender may have unique criteria for evaluating information that can be reflected in the questions asked in the application entry process. In block 94, the application folder 90 shows items that are completed or need to be completed, based on loan filing rules of the selected lender, such as collateral selection, loan submission worksheet, co-applicant, application status, credit status, funding status, and documentation. These items are electronic hyperlinks to lower data entry screens or webpages from the application folder for providing the necessary information for the lender. The customer and loan information contained in application folder 90 and the corresponding lower data entry screens or webpages can be populated with the basic customer information and applicant credit profile retrieved from the credit bureau.

The links in block 94 can be used by the dealer as a launching pad to go complete each lender-tailored item. The selected lender governs what type of information is collected, and in what level of detail, to permit an evaluation using the lender's criteria, rather than using the criteria presented and gathered in a standard form. Block 96 illustrates the credit bureau information for the customer including a link to pull a credit report and an indicator of what credit bureaus have already been pulled. Block 98 is typically presented after block 94 is completed and is used to send messages directly to the lender's credit department. Block 100 is a convenient copy tool which is used to copy the existing application to a new application folder. The copy tool saves the effort of re-entering loan information.

The fields in application folder 90 are dynamically presented based on the present status and pending actions needed in the loan application. For example, the circle adjacent to applicant remains a question mark until the applicant information is completed, i.e., the question marks indicate item(s) not yet complete, but which are required by the selected lender. Likewise, the circle adjacent to the loan submission worksheet remains a question mark until the loan submission worksheet is completed. Once the loan submission worksheet is complete in accordance with the lender rules, the circles change to a checkmark. Certain fields in the application folder 90 will not appear until other fields have been completed. For example, the funding status field will not appear until the loan submission worksheet is complete, and the documentation field will not appear until the loan has been approved. Submit button 101 and comment window 102 appears only when the loan application is ready to submit to the lender. Accordingly, the application folder forces the dealer to comply with rules of the lender. It is only after the requisite information is completed or comes back from the lender, as a result of complying with the rules, that the application folder allows the dealer to continue to the next step.

One of the features of asset financing system 10 is the ability to customize collateral selection screens. Asset financing system 10 supports many different types of collateral, and each is customized to provide a high level of detail for each collateral type. The types of collateral may include RVs, automotive, marine, power sports, aircraft, home improvement, and the like. The customized collateral screens are beneficial to the dealers and lenders alike to get a complete and accurate representation of the collateral being offered. In many cases, the collateral selection screen increases the value of the asset being offered as security and enhances the probability of loan approval by the lender.

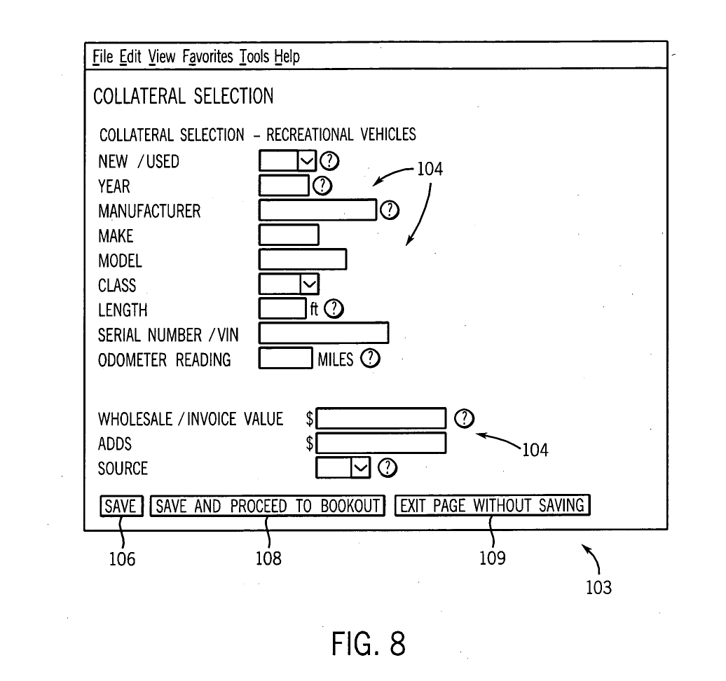

Once the application folder is created, a typical first step is to identify and define the collateral. Asset financing system 10 provides a collateral selection screen which is configurable based on the type of collateral being offered, e.g., RVs, autos, marine, etc. A collateral selection screen 103 is shown in FIG. 8 to support RVs. Screen 103 allows the dealer to enter information related to the collateral being used to secure the loan. Collateral information includes fields 104 for new/used status, year, manufacturer, make, model, class, length, serial number or vehicle identification number, odometer reading, wholesale or invoice value, and source. Some fields are mandatory; some fields are optional. Mandatory fields are so marked. Asset financing system 10 performs validity checking on the data for one or more of the fields 104. The system confirms the content, value range, and format on a real-time basis as the data is entered by the dealer, according to the selected lender's rules. The fields 104 are configured for the dealer to enter the data directly by keyboard or use the mouse to pull down selections of pre-defined values. Screen 103 is also configurable based on the lender's requirements. Each lender may have specific information needed for each collateral type. Each lender may specify different fields as mandatory or subject to data validation. The valid fields 104 for each collateral type, and for each lender, are stored in the database on server 40. Screen 103 also has save button 106, save and proceed to book out button 108, and exit without saving button 109.

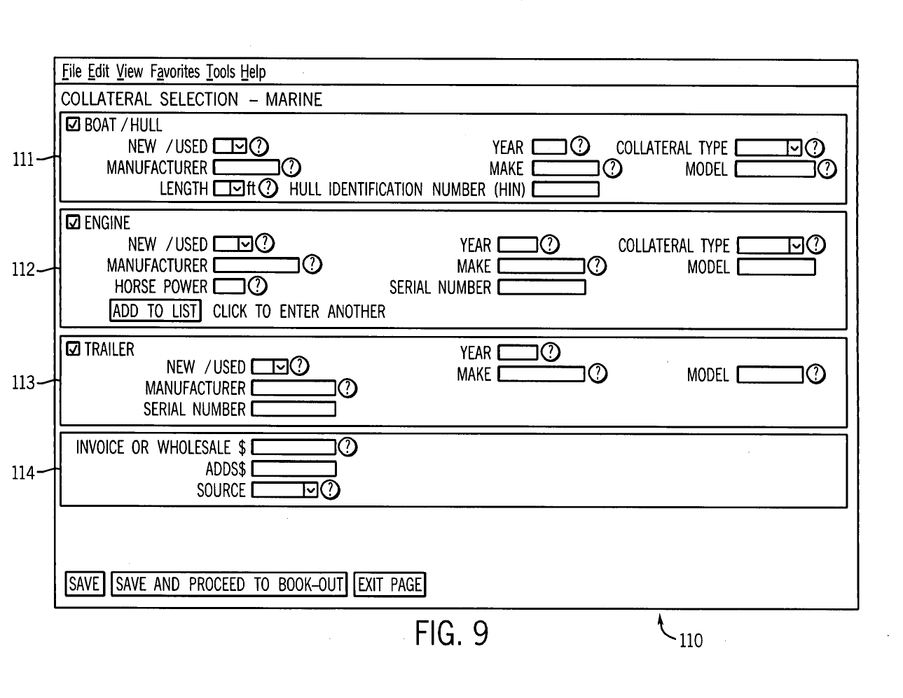

Another collateral selection screen 110 is shown in FIG. 9. Collateral selection screen 110 is customized for marine forms of collateral. Block 111 has fields for the boat or hull, e.g., year, manufacturer, make, length, etc. Block 112 has fields for the engine, e.g., year, manufacturer, horsepower, serial number, etc. Block 113 has fields for the boat trailer, e.g., year, manufacturer, make, model, serial number, etc. Block 114 has fields for pricing information. Collateral selection screen 110 presents three items of marine collateral to secure the loan: the boat, engine, and trailer. Each has value and, as presented, the combination is likely to yield more collateral value than if the marine asset was listed as a single unit. Collateral selection screen 110 is thus customized for the type of asset and presents more information than would otherwise be available to the lender for evaluation of the loan. Collateral selection screen 110 can also be customized for the selected lender, who may want more or less information for certain types of collateral. The customization information is stored in asset financing system database.

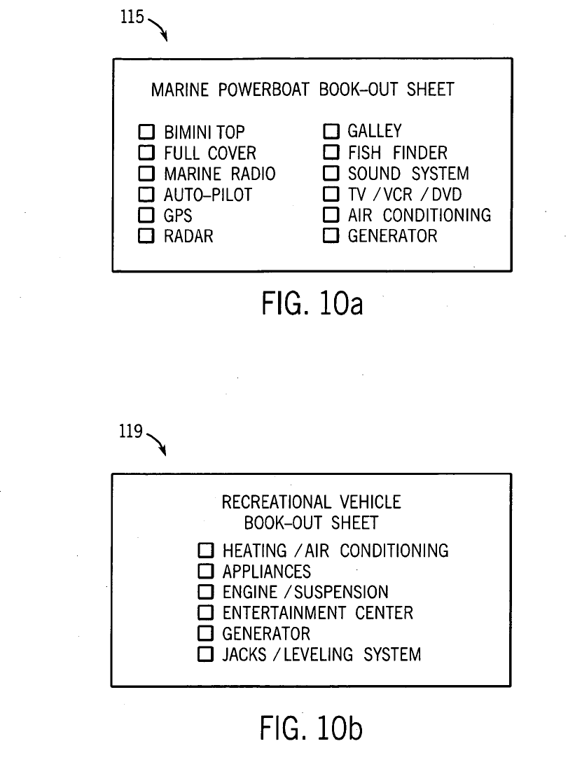

Each of the collateral selection screens may have a book-out sheet for providing further detail about the asset being offered to secure the loan. An example is shown in FIG. 10a as marine powerboat book-out sheet 115. The book-out sheet provides additional attributes of the collateral which in most cases will tend to increase its value, e.g., accessories, special features, and other add-ons. In some cases, the book-out sheet may tend to decrease the value of the asset, e.g., high hours on the engine, but in general the fair market value of the collateral is better ascertained for the lender by using the book-out sheet. FIG. 10b illustrates an RV bookout sheet 119. The bookout sheet 119 shows additional accessories, special features, and other add-ons of RV-type collateral which in most cases will tend to increase its value.

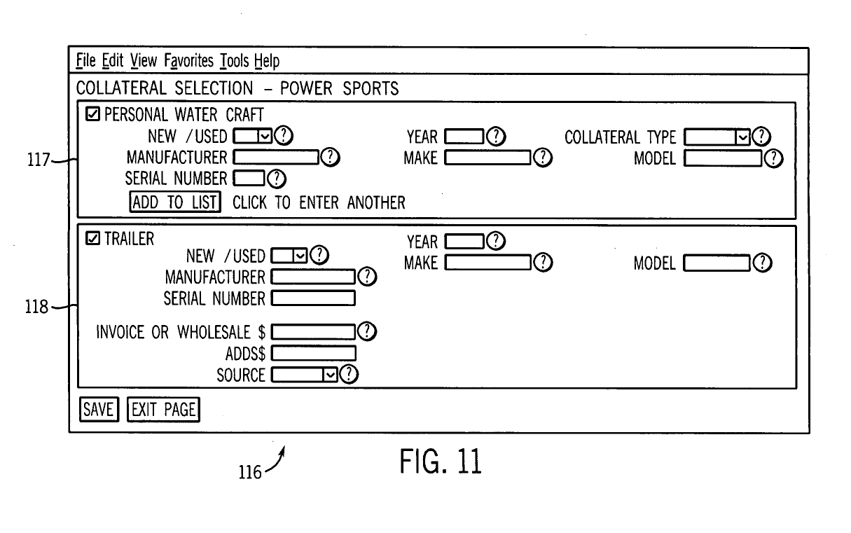

Yet another collateral selection screen 116 is shown in FIG. 11. Collateral selection screen 116 is customized for power sports forms of collateral. Block 117 has fields for the personal water craft, e.g., year, manufacturer, make, length, etc. Block 118 has fields for the trailer, e.g., year, manufacturer, make, model, serial number, etc. Collateral selection screen 116 presents two items of collateral to secure the loan: the personal water craft and trailer. Each has value and, as presented, the combination is likely to yield more collateral value than if the marine asset was listed as a single unit.

Asset financing system 10 may also have collateral selection screens for automobiles, home improvement, industrial equipment, and any other form of collateral. Each collateral selection screen is customized for the type of asset and presents more information than would otherwise be available to the lender for evaluation of the loan. Each collateral selection screen can also be customized for the lender, who may want more or less information for certain types of collateral. The customization information is stored in asset financing system database.

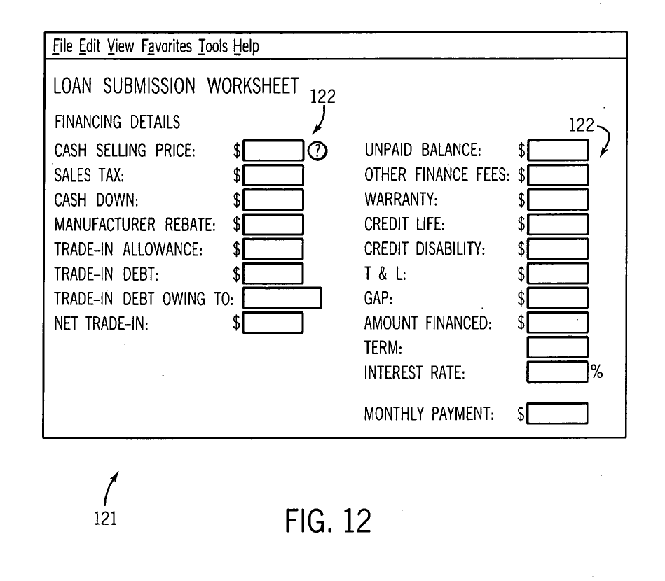

Once the collateral is defined, the next step is to complete a loan submission worksheet, such as shown in FIG. 12 to support the loan structure for application folder 90. Webpage or data entry screen 121 allows the dealer to enter financing information related to the loan request. The financing information includes fields 122 for cash selling price, sales tax, cash down, manufacturer rebate, trade-in allowance, trade-in debt, trade-in debt owed to, net trade-in, unpaid balance, other finance fees, warranty, credit life, credit disability, tags and licensing, GAP, amount financed, term, interest rate, and monthly payment. Again, some fields are mandatory; some fields are optional. Mandatory fields are so marked. Asset financing system 10 performs validity checking on the data for one or more of the fields 122. The system confirms the content, value range, and format on a real-time basis as the data is entered by the dealer, according to the lender's rules. The fields 122 are configured for the dealer to enter the data directly or use pull down selections of pre-defined values. Screen 121 is configurable based on the lender. Each lender may have specific information needed for each loan structure. Each lender may specify different fields as mandatory or subject to data validation. The valid fields 122 for each loan structure, and for each lender, are stored in the database on server 40.

One feature of asset financing system 10 is a pre-approval option for the dealer. Dealers are always anxious to finalize the deal with the customer and deliver the unit. Once the loan information has been collected, i.e., applicant, co-applicant, collateral selection, and loan submission worksheet, the dealer can optionally choose to have the asset financing system 10 execute a pre-approval process. The system stores the business rules and standards of each lender in the database on server 40. In the pre-approval process, the dealer requests approval through the asset financing system before formally submitting the loan application to the lender. As a first threshold check, the system evaluates the particulars of the loan and can block or void the pre-approval process if not within the standards of the lender. The asset financing system performs substantially the same analysis that will be conducted by the selected lender when the loan application is actually submitted. Each lender authorizes the pre-approval process based on its relationship with the dealer. Instead of immediately submitting the loan application to the lender, the dealer can request pre-approval through the asset financing system which runs the selected lender's analysis on the collective loan information and returns a pre-approval decision. The system confirms that the applicant's loan information, such as credit history, date pulled, beacon score, minimum trade lines, no bankruptcy, is compliant with business rules of the lender. The pre-approval process is not intended to select the lender, but rather to determine whether the selected lender will indeed approve the loan.

If the pre-approval decision is positive, the dealer is so notified by the asset financing system. The dealer can complete the sales or leasing transaction with the customer, i.e., prep and deliver the purchased asset, with high confidence that the loan will be approved once it is formally submitted to the lender, assuming the collective loan information is accurate. The loan application must still ultimately be submitted to the lender, and the lender still has the final approval, but the pre-approval process dramatically decreases the waiting time for a first level decision and gives the dealer assurance that the sale transaction can proceed. With the pre-approval process, there is no longer any reason to shotgun loan applications.

Returning to FIG. 7, additional data entry screens may need to be completed depending on the lender's requirements. Once the dealer has entered all required information for the applicant, co-applicant (if any), collateral selection, and loan worksheet, as per the selected lender standards, the loan application is ready for submission to the lender. The icons for the links in block 94 change to a checkmark to show the loan application is complete and validated for the selected lender. The submit button 101 and comments window 102 dynamically appear and the dealer can transfer the completed credit application to the lender.

As discussed, certain fields in FIG. 7 are not presented until the prior steps have been completed. For example, depending on the configuration of the asset financing system as well as the lender rules, the documentation field may not appear until the lender has approved the loan. Once the lender has okayed the loan, then the dealer can print the loan documents, as compiled from the collective loan information, and fax or mail to the lender. Asset financing system 10 prepares the loan documents to be compliant with applicable laws in the subject jurisdiction. The system can also electronically fax the documents to the lender. Since the loan documents are compiled from the applicant's loan information, which has already been formatted and validated according the lender's rules, the loan documents are substantially error free.

Alternatively, the collective loan information can be transmitted electronically over communication network 42 to the lender's computer, e.g., computer system 46. The electronic transmission may include an electronic signature of the customer. In either case, by using the collective loan information, the asset financing system reduces or eliminates many common errors in the loan documents. The loan documents, as compiled from the properly formatted and validated fields of the data entry screens, according to the selected lender's rules, avoids the aforementioned problems of unduly complex forms, data entry errors, confusion, lender variances, misprinted forms, and general human error. Since asset financing system 10 is aware of the requirements of each lender, the loan documents should be received and processed by the selected lender with few, if any, rejections for non-compliance.

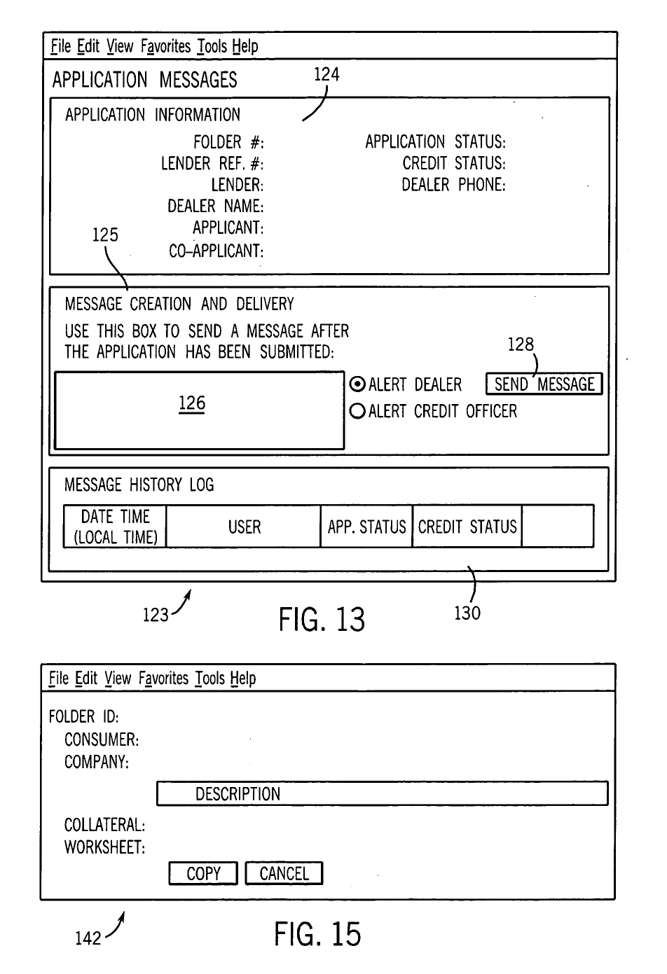

Another feature of asset financing system 10 is shown in FIG. 13. Data entry screen 123 is used for interactive communications and electronic messaging between the dealer and lender. Block 124 provides application information for the loan in question. Block 125 is used for the dealer to enter questions and comments for the selected lender. The message is typed into window 126 and the dealer clicks the send message button 128 to transmit the electronic message to the lender. A message history log from dealer to lender and from lender to dealer is provided in block 130. The application messaging function provides a real-time electronic dialog between the dealer and lender.

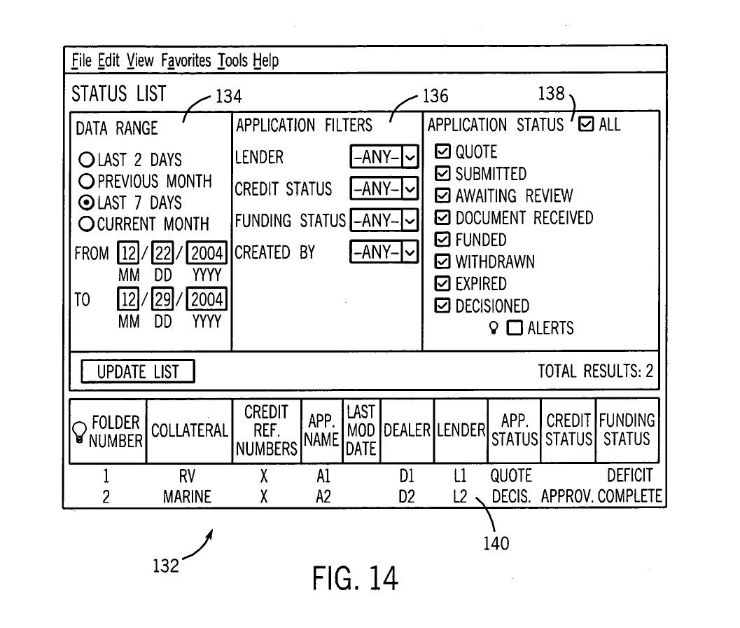

In FIG. 14, screen 132 illustrates the status list function 64 from FIG. 4. The status list searches for existing dealer application folders that match the filter or search criteria. The dealer can specify date range in block 134, application filter (lender, credit status, funding status, created by) in block 136, and application status (quote, submitted, awaiting review, document received, funded, withdrawn, expired, decision'ed, alerts) in block 138. Block 140 displays the application folders matching the filter or search criteria as provided by the dealer in blocks 134-138.

The asset financing system 10 can be configured to communicate with the lender's computer system to track the loan approval process with the lender. The dealer can confirm that the lender has received the loan application. The dealer can check on application status and deal history with the lender, on a step-by-step basis. The loan approval processing steps are shown in detail, both with the dealer and in the lender's hands. The status list allows the dealer to focus on deals that need attention, e.g., conditional approvals and questions from the lender. The status list increases the efficiency of the dealer in servicing the customer's loan application and getting all deals completed and funded in the least amount of time.

In addition to the data entry fields of the webpages in the asset financing system 10 being configurable to the lender specific requirements, the communication protocol with each lender can also be customized. The lender can set the communication standards and the asset financing system 10 will adapt to the given standards. Asset financing system 10 is thus dealer and lender friendly.

In FIG. 15, screen 142 illustrates the application copy function. One application folder can be copied to another application folder. The application copy function is useful in certain cases, e.g., when the selected lender rejects the loan application and the dealer needs to submit a different application to the selected lender with a different asset purchase or different applicants.

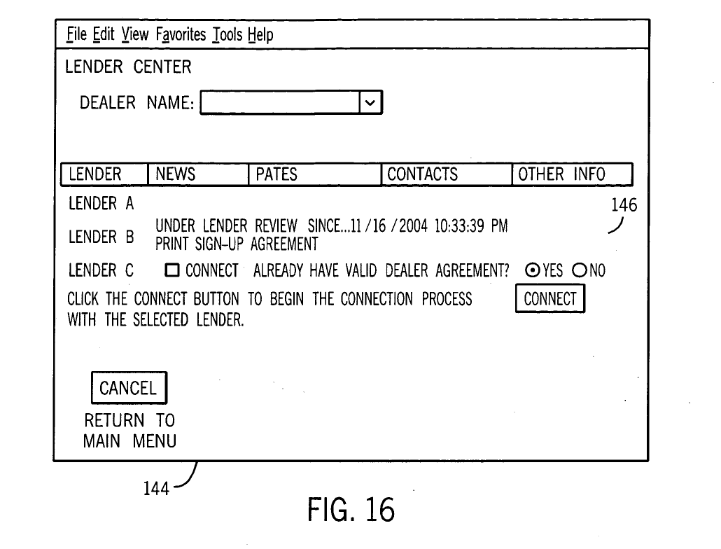

Yet another feature of asset financing system 10 is the lender center function 144 as shown in FIG. 16. The lender center is a forum for communications with the dealer and lender. In block 146, the system maintains lender information, such as news, announcements, loan programs, interest rate sheets, internal contacts, hours of operation, which is made available for approved dealers. The access is permission based for approved dealers. The lender center gives the lender the ability to approve what information is available on a dealer by dealer basis. The lender center also provides a mechanism for the dealer sign up with specific lenders and/or change their level of service and status. Dealers can see which lenders they are approved through, which dealers are part of the host system they may want to enroll with, and the status of any pending applications for enrollment. Dealers must execute an agreement with each lender in order to submit loan applications to the respective lender. The lender center can also be used to enroll dealers with credit bureaus. Dealers and lenders can see historical transactions with statistical reports and summaries. The lender center can be used by the host to conduct surveys and receive suggestions from dealers and lenders to learn ways to improve the system operation and features. Asset transaction system 10 gives all parties, i.e., lenders, dealers, and credit bureaus alike, the ability connect and communicate with one another.

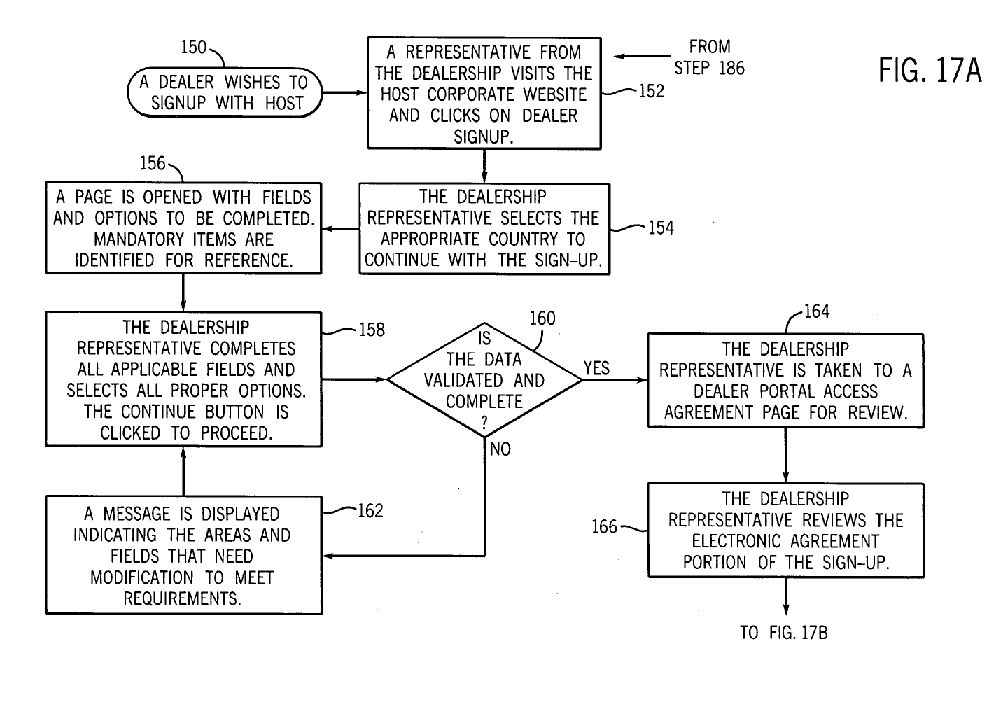

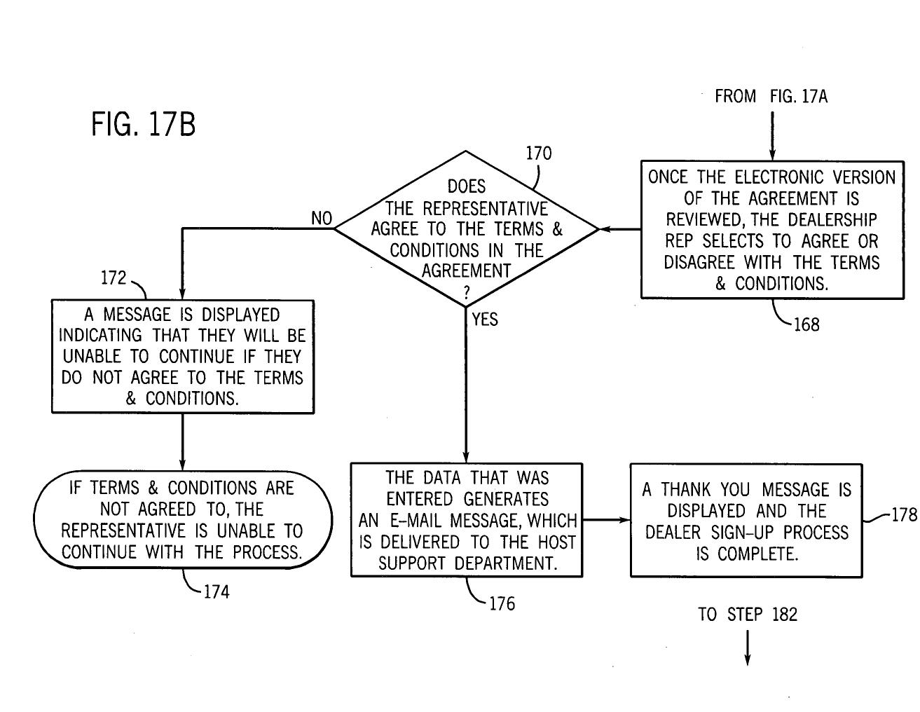

A flowchart of the dealer signup process is shown in FIGS. 17a-17b. In step 150, a dealer signs up with the host. In step 152, a representative from the dealership visits the host corporate website and clicks on the dealer signup button. In step 154, the dealership representative selects the appropriate country to continue with the signup. In step 156, a page is opened with fields and options to be completed. Mandatory items are identified for reference. In step 158, the dealership representative completes all applicable fields and selects all proper options. In step 160, if the data is not validated and completed, then a message is displayed in step 162 indicating the blocks and fields that need modification to meet requirements. The process returns to step 158. In step 160, if the data is validated and completed, then the dealership representative is taken to a dealer portal access agreement page for review in step 164. In step 166, the dealership representative reviews the electronic agreement portion of the signup. In step 168, once the electronic version of the agreement is reviewed, the dealership representative selects whether to agree or disagree with the terms and conditions. In step 170, if the dealership representative does not agree with the terms and conditions in the agreement, then a message is displayed in step 172 indicating that they will be unable to continue if they do not agree to the terms and conditions. In step 174, if the terms and conditions are not agreed to, the dealership representative is unable to continue with the dealer signup process. In step 170, if the dealership representative does agree with the terms and conditions in the agreement, then the data that was entered generates an email message, which is delivered to the host support department in step 176. In step 178, a thank you message is displayed and the dealer signup process is complete. The process continues to step 182.

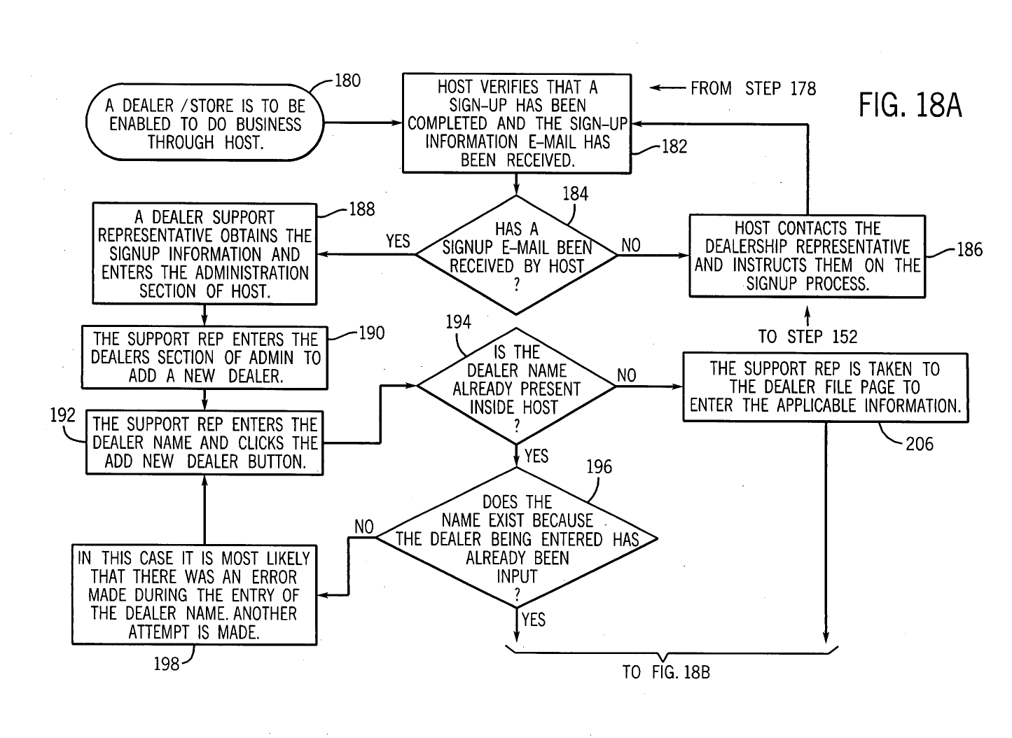

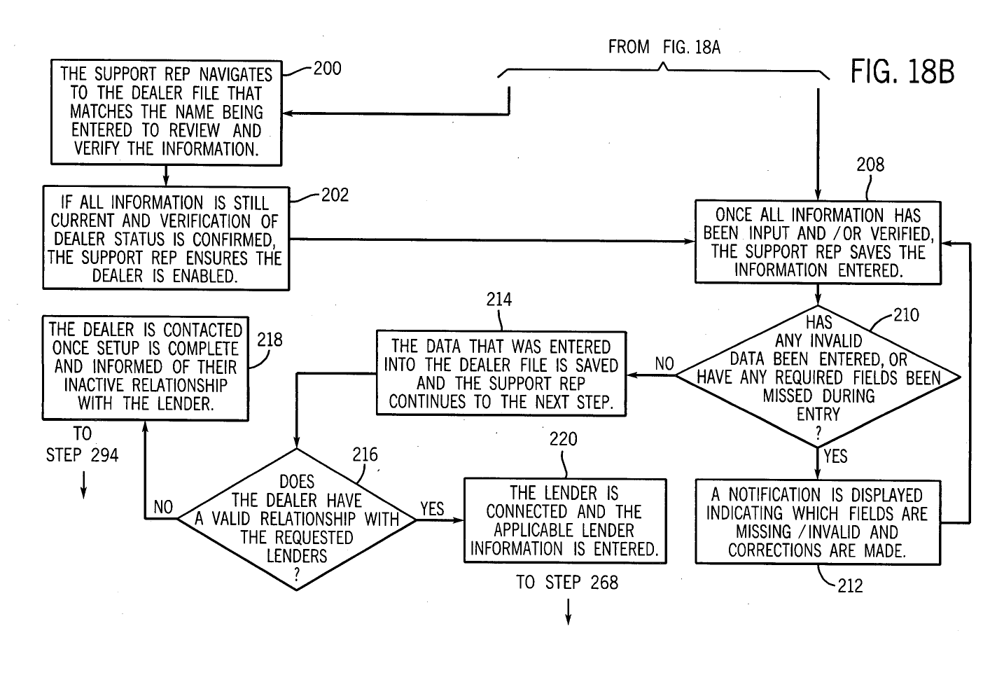

A flowchart of the dealer setup process to use the asset financing system 10 is shown in FIGS. 18a-18b. In step 180, a dealer/store is enabled to do business through the host. In step 182, the host verifies that a signup has been completed and the signup information email has been received. In step 184, if a signup email has not been received by the host, then the host contacts the dealership representative in step 186 and instructs them on the signup process. The dealer setup process returns to step 182. In step 184, if a signup email has been received by the host, a dealer support representative obtains the signup information and enters the administration section of the host in step 188. Only host users with the proper permission group are able to enter the administration section. In step 190, the support representative enters the dealers section of administration to add a new dealer. In step 192, the support representative enters the dealer name and clicks the add new dealer button. If the dealer name is already present inside the host in step 194, and the name does not exist in step 196, then another attempt is made in step 198 as there was most likely an error made during the entry of the dealer name. The dealer setup process continues to step 192. If the dealer name is already present inside the host in step 194, and the name does exist in step 196, then the support representative navigates to the dealer file that matches the name being entered to review and verify the information in step 200. In step 202, the support representative ensures the dealer is enabled, assuming all information is still current and verification of dealer status is confirmed. The dealer setup process continues to step 208. In step 194, if the dealer name is not already present inside the host, then the support representative is taken to the dealer file page to enter the applicable information in step 206. In step 208, once all information has been input and/or verified, the support representative saves the information entered. In addition to the name, address, phone number, the support representative must indicate the host sales representative that is responsible for the dealership. The selection of the representative allows the sorting and commission payment for each host representative. In step 210, if any invalid data has been entered, or if any required fields have been missed during entry, then a notification is displayed in step 212 indicating which fields are missing/invalid and corrections are made. The dealer setup process returns to step 208. In step 210, if no invalid data has been entered, or if no required fields have been missed during entry, then the data that was entered into the dealer file is saved in step 214 and the support representative continues to step 216. In step 216, if the dealer does not have a valid relationship with the requested lenders, then the dealer is contacted once setup is complete and informed of their inactive relationship with the lender in step 218. The process continues to step 294. In step 216, if the dealer has a valid relationship with the requested lenders, then the dealer and lender are connected and the applicable lender information is entered in step 220. The process continues to step 268. The dealer must have an active relationship with at least one lender to be enabled or remain enabled.

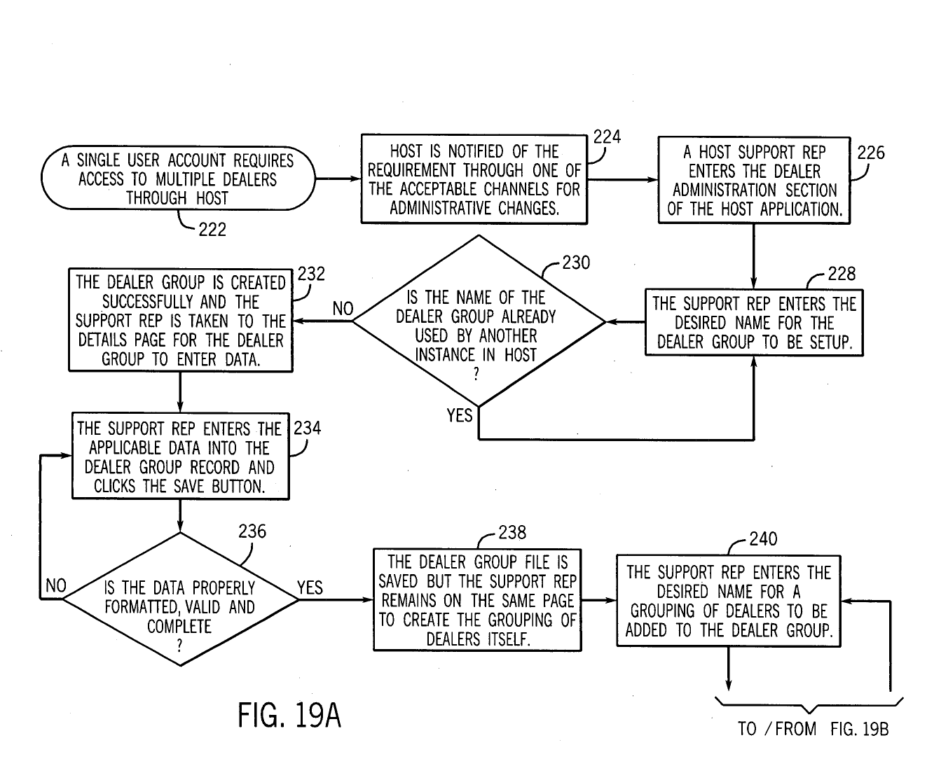

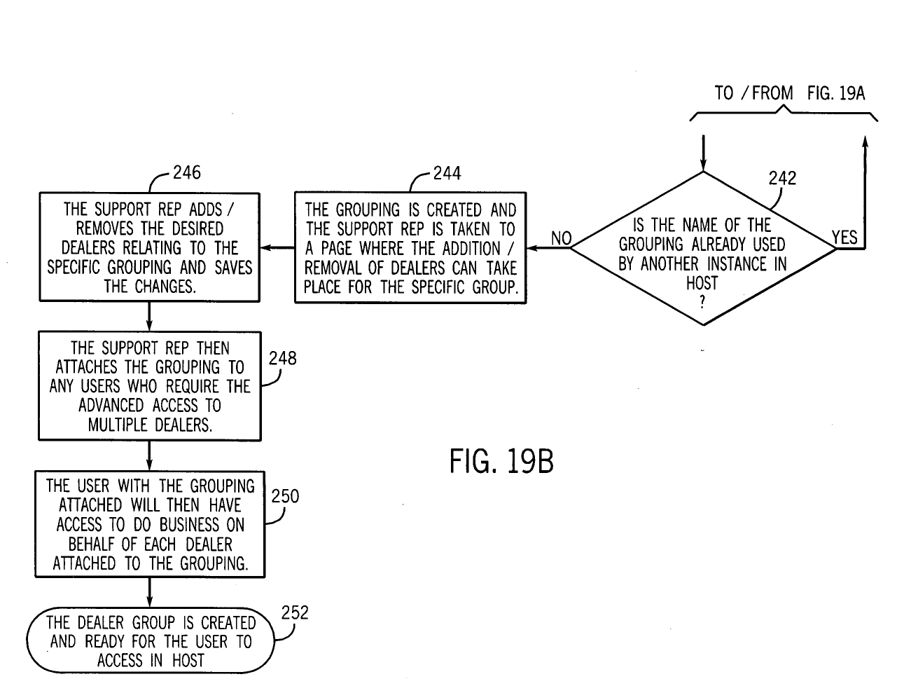

A flowchart of the dealer group process is shown in FIGS. 19a-19b. In step 222, a single user account requires access to multiple dealers through the host. In step 224, the host is notified of the requirement through one of the acceptable channels for administrative changes. The host only accepts requests for administrative changes through certain channels including comments box, support request, host sales manager, and dealer signup. In step 226, a host support representative enters the dealer administration section of the host application. In step 228, the support representative enters the desired name for the dealer group to be set up. In step 230, if the name of the dealer group is already used by another instance in the host, then the dealer group process returns to step 228. In step 230, if the name of the dealer group is not already used by another instance in the host, then the dealer group is created successfully and the support representative is taken to the details page for the dealer group to enter data in step 232. In step 234, the support representative enters the applicable data into the dealer group record and clicks the save button. In step 236, if the data is not properly formatted, valid and complete, then the dealer group process returns to step 234. In step 236, if the data is properly formatted, valid and complete, then the dealer group file is saved but the support representative remains on the same page to create the grouping of dealers itself in step 238. In step 240, the support representative enters the desired name for a grouping of dealers to be added to the dealer group. In step 242, if the name of the dealer grouping is already used by another instance in the host, then the dealer group process returns to step 240. In step 242, if the name of the dealer grouping is not already used by another instance in the host, then the dealer grouping is created in step 244 and the support representative is taken to a page where the addition/removal of dealers can take place for the specific group. In step 246, the support representative adds/removes the desired dealers relating to the specific grouping and saves the changes. In step 248, the support representative attaches the dealer grouping to any users who require the advanced access to multiple dealers. In step 250, the user with the dealer grouping attached will then have access to do business on behalf of each dealer attached to the grouping. Each user attached to a dealer group will have access only to that dealer's information. In step 252, the dealer group is created and ready for the user to access in host.

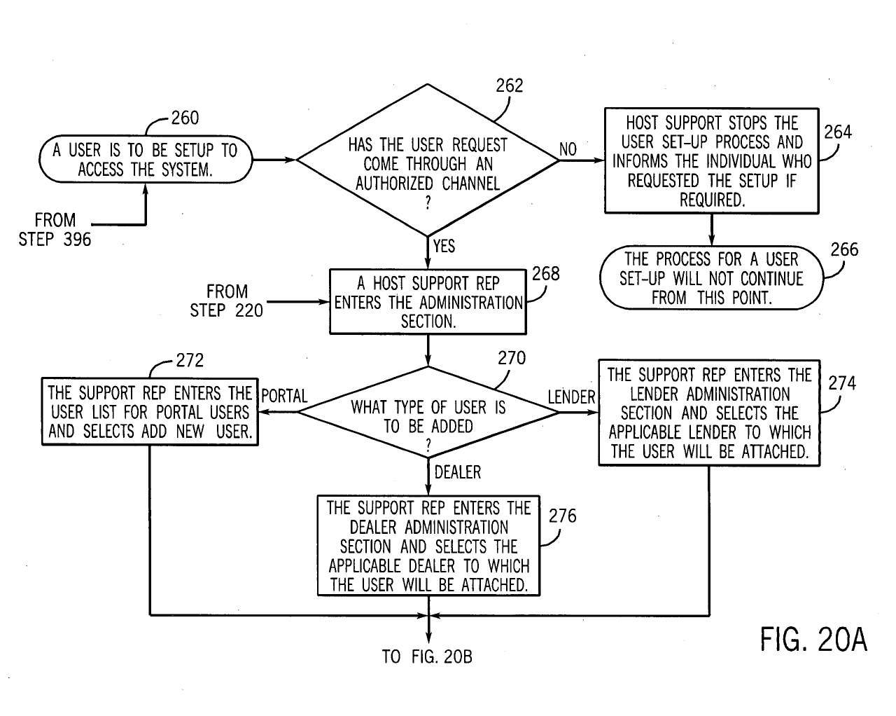

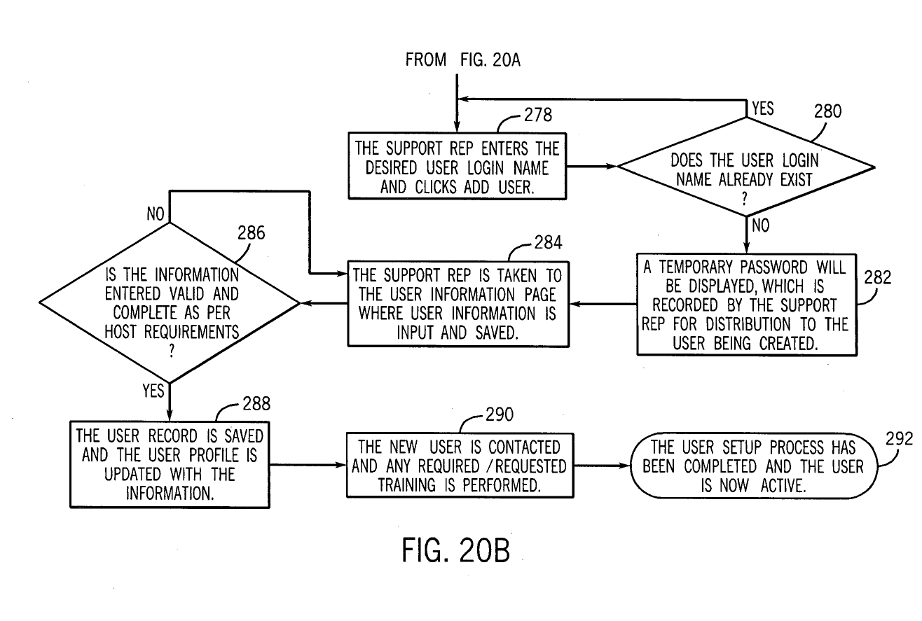

A flowchart of the user setup process is shown in FIGS. 20a-20b. In step 260, a user is set up to access the system. In step 262, if the user request has not come through an authorized channel, then the host support stops the user setup process and informs the individual who requested the setup in step 264. In step 266, the process for a user setup will not continue from this point. In step 262, if the user request has come through an authorized channel, then a host support representative enters the administration section in step 268. Authorized channels include comments box, support request, host sales manager, and received dealer signups. Only host users with the proper permission are able to enter the administration section. In step 270, if the portal type of user is added, then the support representative enters the user list for portal users and selects add new user option in step 272. The user setup process continues to step 278. In step 270, if the lender type of user is added, then the support representative enters the lender administration section and selects the applicable lender to which the user will be attached in step 274. The user setup process continues to step 278. In step 270, if the dealer type of user is added, then the support representative enters the dealer administration section and selects the applicable dealer to which the user will be attached in step 276. The user setup process continues to step 278. The type of user determines the permissions and restrictions within the host. The permissions determine access and visibility of various items inside the application. Each permission group is constructed to best suit the function of that user type. In step 278, the support representative enters the desired user login name and clicks add user. In step 280, if the user login name already exists, then the user setup process returns to step 278. In step 280, if the user login name does not already exist, then a temporary password will be displayed in step 282. The temporary password is recorded by the support representative for distribution to the user being created. In step 284, the support representative is taken to the user information page where user information is input and saved. In step 286, if the information entered is not valid and complete as per the host requirements, then the user setup process returns to step 284. In step 286, if the information entered is valid and complete as per the host requirements, then the user record is saved and the user profile is updated with the information in step 288. In step 290, the new user is contacted and any required/requested training is performed. In step 292, the user setup process has been completed and the user is now active.

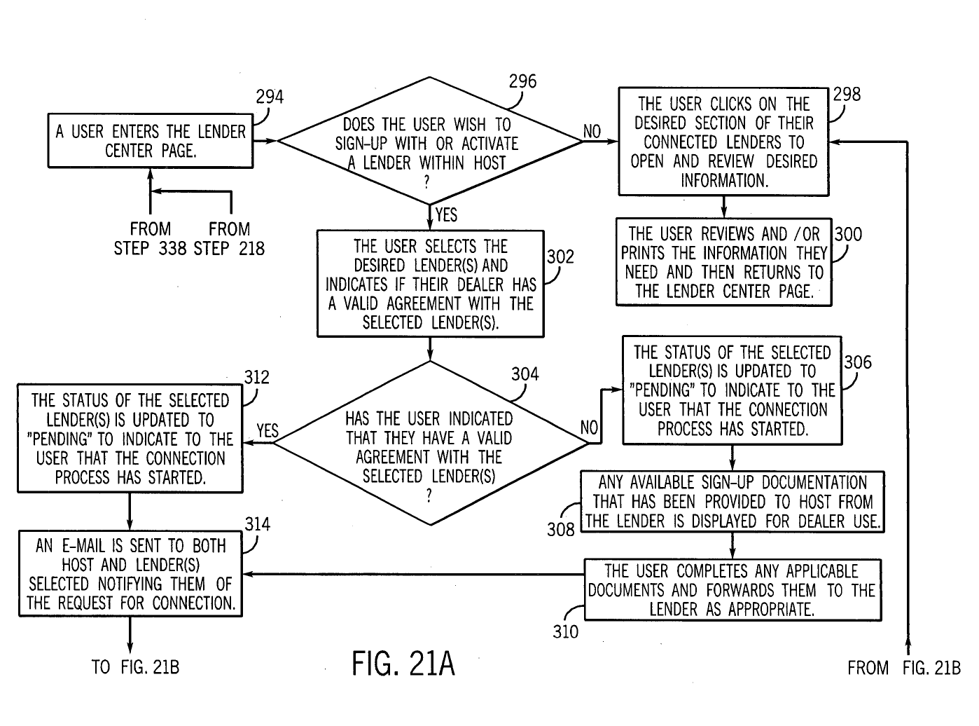

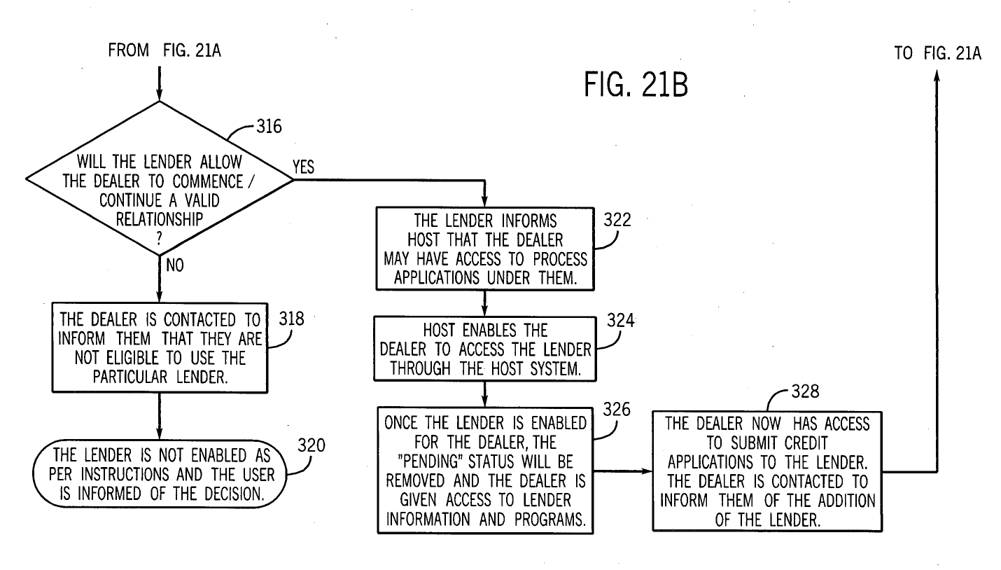

A flowchart of the lender center process is shown in FIGS. 21a-21b. In step 294, a user enters the lender center page. The lender center is only visible to designated users. Lender users do not have access to lender center and dealer users only have limited access to see lenders appropriate to availability. In step 296, if the user does not wish to sign up with or activate a lender within the host, then the user clicks on the desired section of their connected lenders to open and review desired information in step 298. The lender center has the capability to review lender announcements, rates, bulletins, contacts and other information. The lender information is only visible once a lender is connected to a dealer. In step 300, the user reviews and/or prints the information they need and then returns to the lender center page. In step 296, if the user does wish to signup with or activate a lender within the host, then the user selects the desired lender(s) and indicates if their dealer has a valid agreement with the selected lender(s) in step 302. In step 304, if the user has not indicated that they have a valid agreement with the selected lender(s), then the status of the selected lender(s) is updated to “pending” to indicate to the user that the connection process has started in step 306. In step 308, any available signup documentation that has been provided to the host from the lender is displayed for dealer use. In some cases, a lender will provide the host with electronic versions of their signup documentation for integration into the portal. In these cases, the host will develop customized data input pages to populate the forms with user entry data. Once complete, the user can print the populated forms and forward them to the lender for review. In step 310, the user completes any applicable documents and forwards them to the lender as appropriate. The lender center process continues to step 314. In step 304, if the user has indicated that they have a valid agreement with the selected lender(s), then the status of the selected lender(s) is updated to “pending” in step 312 to indicate to the user that the connection process has started. In step 314, an email is sent to both the host and the selected lender(s) notifying them of the request for connection. In step 316, if the lender does not allow the dealer to commence/continue a valid relationship, then the dealer is contacted to inform them that they are not eligible to use the particular lender in step 318. In step 320, the lender is not enabled as per instructions and the user is informed of the decision. In step 316, if the lender does allow the dealer to commence/continue a valid relationship, then the lender informs the host that the dealer may have access to process applications under the lender in step 322. In step 324, the host enables the dealer to access the lender through the host system. The host will not enable a dealer on the system unless authorized by the lender requested. A lender may also request the de-activation of a dealer at any time to prevent the dealer from submitting applications to the lender. In step 326, once the lender is enabled for the dealer, the “pending” status will be removed and the dealer is given access to lender information and programs. In step 328, the dealer now has access to submit credit applications to the lender. The dealer is contacted to inform them of the addition of the lender. The lender center process returns to step 298.

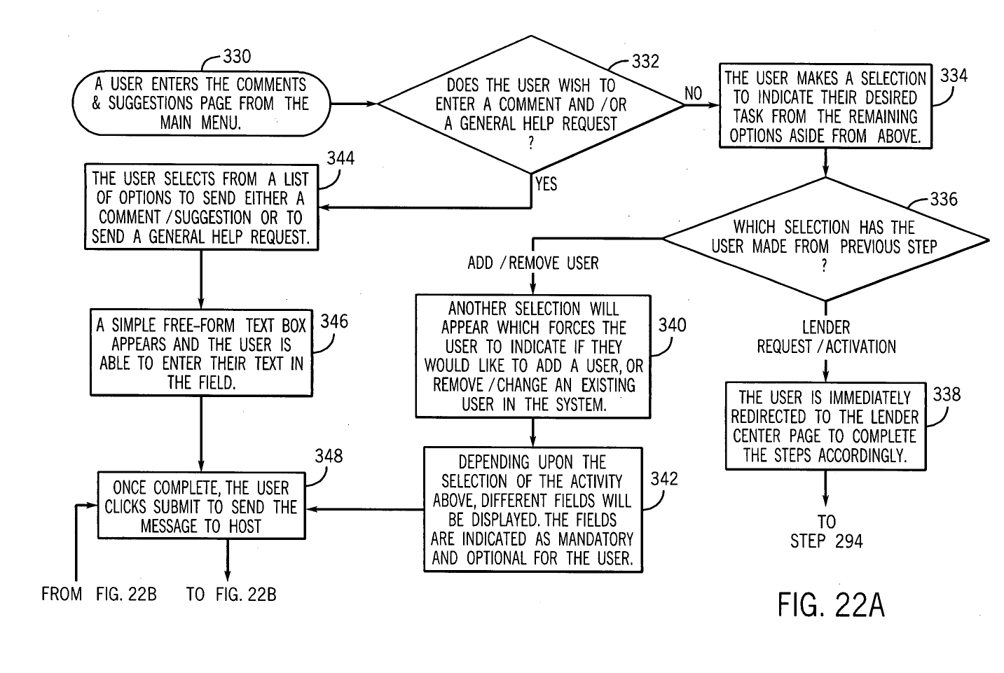

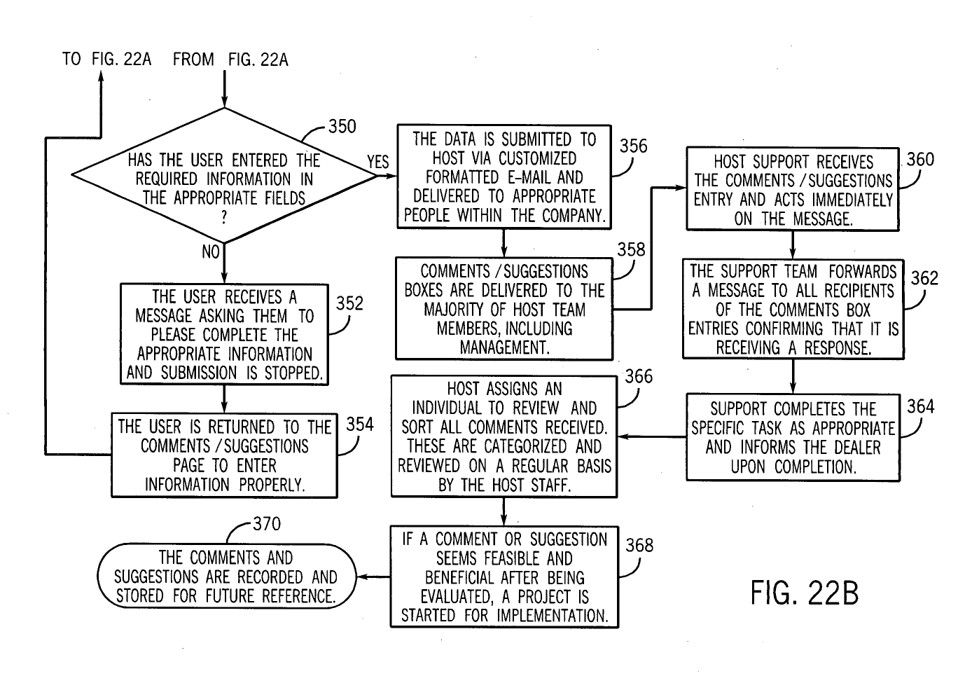

A flowchart of the comments box entries process is shown in FIGS. 22a-22b. In step 330, a user enters the comments & suggestions page from the main menu. In step 332, if the user does not wish to enter a comment and/or a general help request, then the user makes a selection in step 334 to indicate their desired task from the remaining options aside from above. At this point, the only remaining options are “lender request/activation” and “add/remove user.” The user must select one of these options to continue. In step 336, if the user selects lender request/activation, then the user is immediately redirected to the lender center page in step 338 to complete the steps accordingly. The comments box process continues to step 294. In step 336, if the user selects add/remove user, then another selection will appear in step 340 which forces the user to indicate if they would like to add a user, or remove/change an existing user in the system. In step 342, depending upon the selection of the activity above, different fields will be displayed. The fields are indicated as mandatory and optional for the user. The comments box process continues to step 348. Returning to step 332, if the user does wish to enter a comment and/or a general help request, then the user selects from a list of options to send either a comment/suggestion or to send a general help request in step 344. In step 346, a simple free-form text box appears and the user is able to enter their text in the field. In step 348, once complete, the user clicks submit to send the message to the host. In step 350, if the user has not entered the required information in the appropriate fields, then the user receives a message asking them to please complete the appropriate information and submission is stopped in step 352. In step 354, the user is returned to the comments/suggestions page to enter their information properly. The comments box process returns to step 348. In step 350, if the user has entered the required information in the appropriate fields, then the data is submitted to the host via customized formatted email and delivered to the appropriate people within the company in step 356. In step 358, comments/suggestion boxes are delivered to the majority of the host team members, including management. In step 360, the host support team receives the comments/suggestions entry and acts immediately on the message. In step 362, the host support team forwards a message to all recipients of the comments box entries confirming that it is receiving a response. In step 364, the host support team completes the specific task as appropriate and informs the dealer upon completion. In step 366, the host assigns an individual to review and sort all comments received. The comments are categorized and reviewed on a regular basis by the host staff. In step 368, if a comment or suggestion seems feasible and beneficial after being evaluated, a project is started for implementation. In step 370, the comments and suggestions are recorded and stored for future reference.

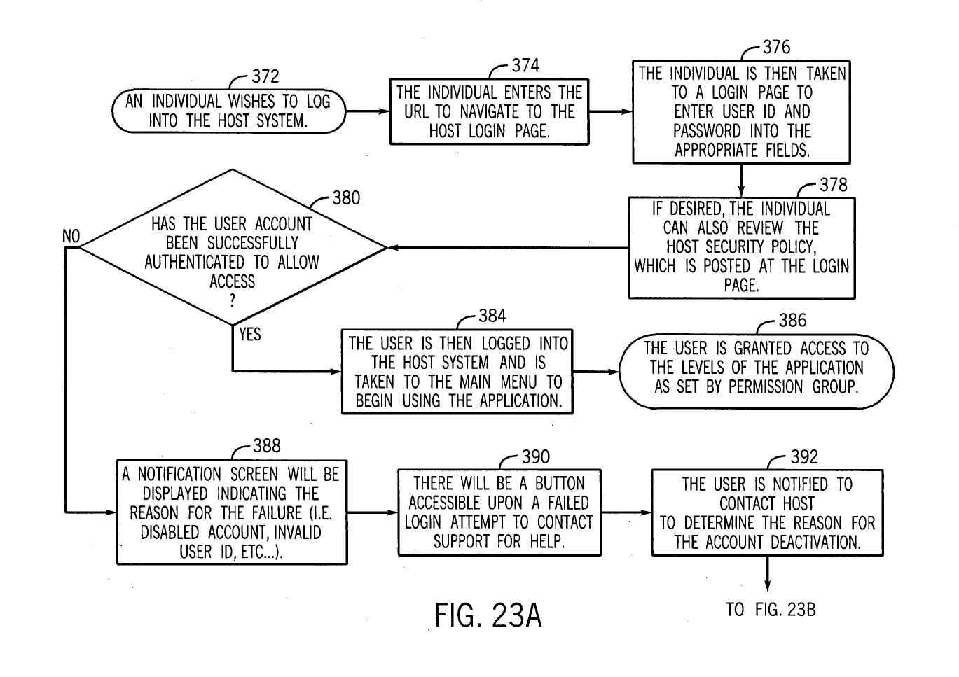

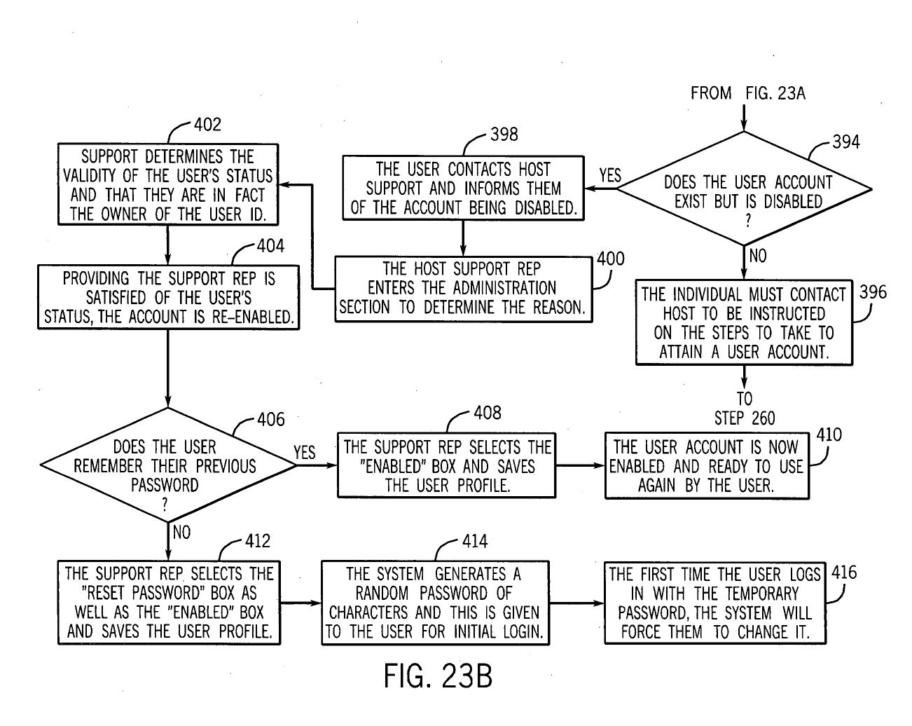

A flowchart of the user login process is shown in FIGS. 23a-23b. In step 372, an individual logs into the host system. In step 374, the individual enters the URL to navigate to the host login page. In step 376, the individual is then taken to a login page where they enter their user id and password into the appropriate fields. In step 378, the individual can also review the host security policy, which is posted at the login page. In step 380, if the user account has been successfully authenticated to allow access, the user is then logged into the host system and is taken to the main menu to begin using the application in step 384. In step 386, the user is granted access to the levels of the application as set by their permission group. In step 380, if the user account has not been successfully authenticated to allow access, then a notification screen will be displayed in step 388 indicating the reason for the failure, e.g., disabled account, invalid User ID, etc. In step 390, a button is made accessible upon a failed login attempt to contact support for help. In step 392, the user is notified that they must contact the host to determine the reason for the account deactivation. The host has the ability to manually disable accounts based on various reasons as outlined in the dealer agreement. A user account may also be deactivated due to a set period of inactivity and/or three failed login attempts to prevent unauthorized access. In step 394, if the user account does not exist, then the individual must contact the host to be instructed on the steps to take to attain a user account in step 396. The user login process continues to step 260. In step 394, if the user account does exist but is disabled, then the user contacts the host support and informs them of the account being disabled in step 398. In step 400, the host support representative enters the administration section to determine the reason. In step 402, the host support representative determines the validity of the user's status and that they are in fact the owner of the user id. The verification of a user's status is done by verifying personal information with the user and/or placing a call to the dealer's telephone number on file. In step 404, the user account is re-enabled provided the host support representative is satisfied of the user's status. In step 406, if the user remembers their previous password, then the host support representative selects the “enabled” box and saves the user profile in step 408. In step 410, the user account is now enabled and ready to use again by the user. In step 406, if the user does not remember their previous password, then the host support representative selects the “reset password” box as well as the “enabled” box and saves the user profile in step 412. In step 414, the system generates a random temporary password of characters. The temporary password is given to the user for initial login. In step 416, the system will force the user to change the password the first time the user logs in with the temporary password.

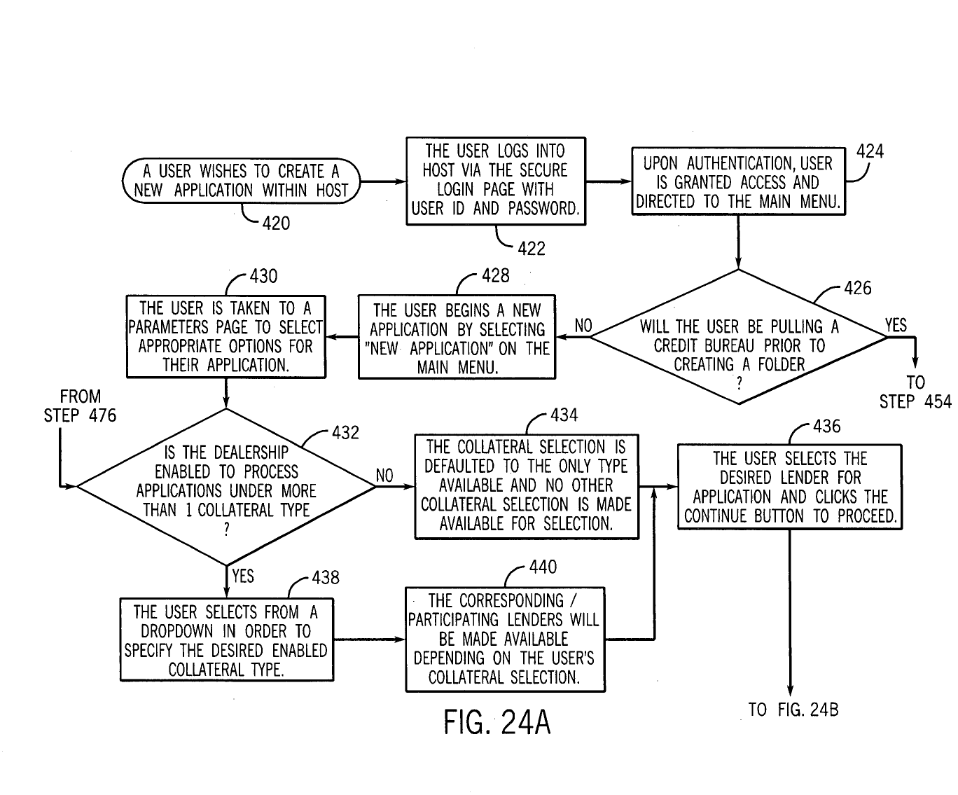

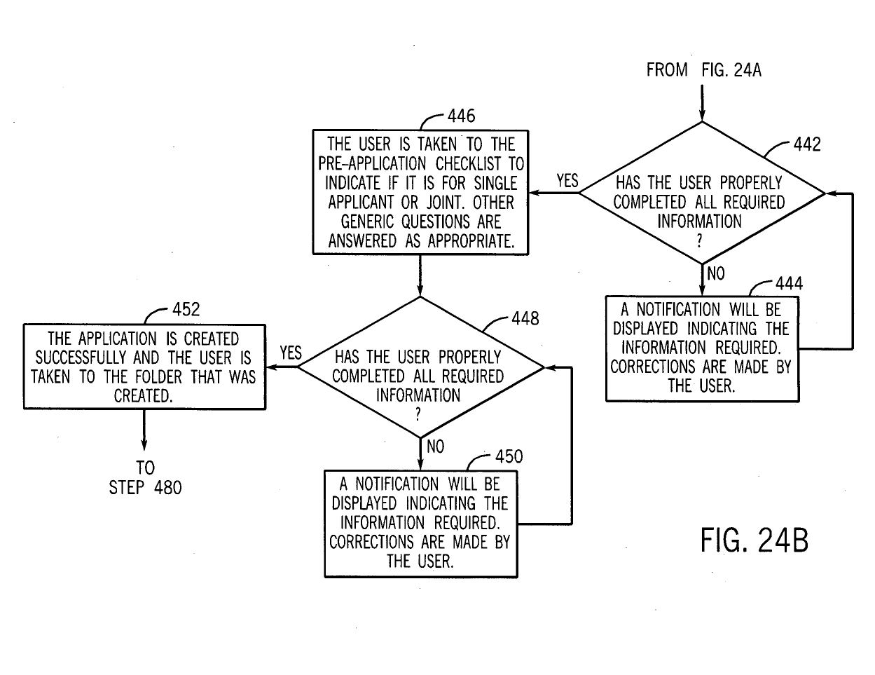

A flowchart of the application creation process is shown in FIGS. 24a-24b. In step 420, a user creates a new application within the host system. In step 422, the user logs into the host system via the secure login page with their user id and password. In step 424, upon authentication, the user is granted access and directed to the main menu. In step 426, if the user pulls a credit bureau report on the applicant prior to creating a folder, then the application creation process continues to step 454. In step 426, if the user does not pull a credit bureau report on the applicant prior to creating a folder, then the user begins a new application by selecting “new application” on the main menu in step 428. Access to the new application is controlled via permissions. Only users with appropriate permission levels are able to create new quotes. In step 430, the user is taken to a parameters page to select appropriate options for their application. In step 432, if the dealership is not enabled to process applications under more than one collateral type, then the collateral selection is defaulted to the only type available and no other collateral selection is made available for selection in step 434. In step 436, the user selects the desired lender for their application and clicks the continue button to proceed. In step 432, if the dealership is enabled to process applications under more than one collateral type, then the user selects from a dropdown menu in order to specify the desired enabled collateral type in step 438. In step 440, the corresponding/participating lenders will be made available depending on the user's collateral selection. The application creation process continues to step 436. In step 442, if the user has not properly completed all required information, then a notification will be displayed indicating the information required in step 444. Corrections are made by the user. The application creation process returns to step 442. In step 442, if the user has properly completed all required information, then the user is taken to the pre-application checklist in step 446 to indicate if the application is for a single applicant or joint applicant. Other generic questions are answered as appropriate. In step 448, if the user has not properly completed all required information, then a notification will be displayed indicating the information required in step 450. Corrections are made by the user. The application creation process returns to step 448. In step 448, if the user has properly completed all required information, then the application is created successfully and the user is taken to the application folder that has been created. The process continues to step 480.

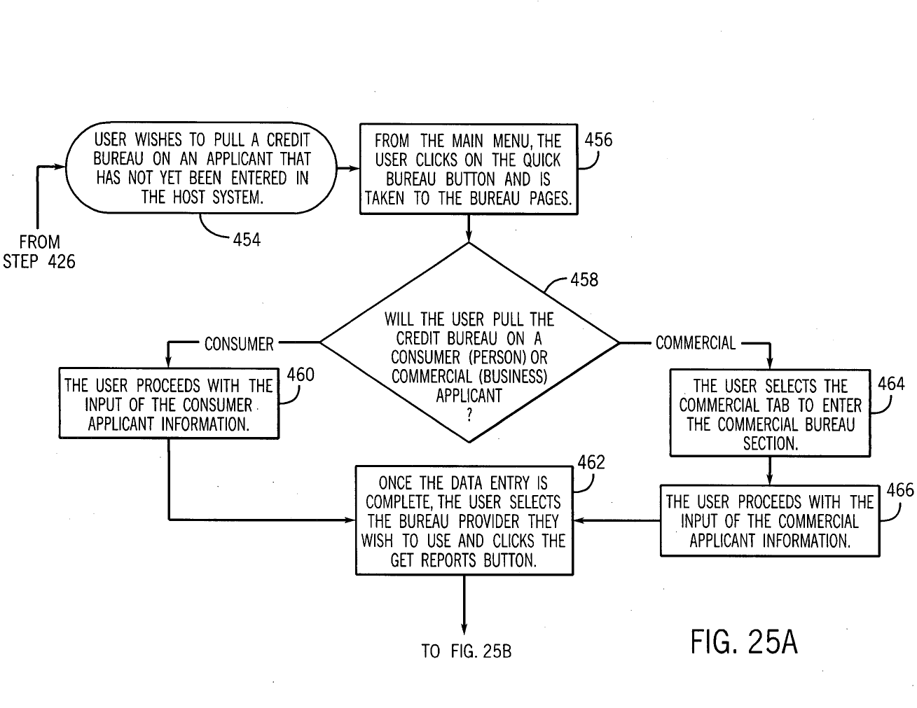

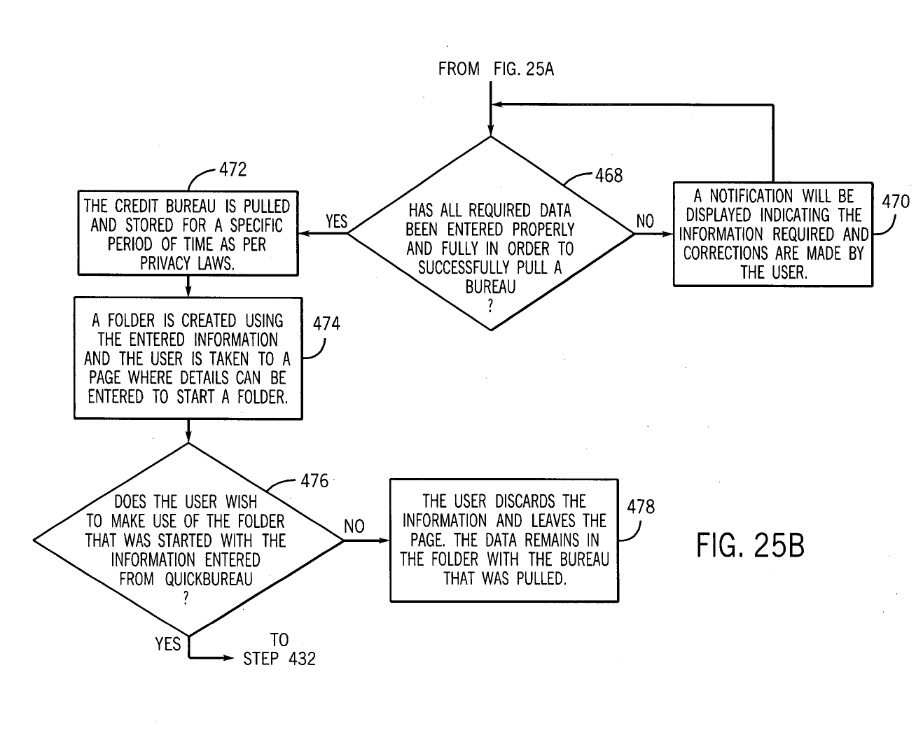

A flowchart of the quick bureau process is shown in FIGS. 25a-25b. In step 454, the user pulls a credit bureau report on an applicant that has not yet been entered in the host system. In step 456, from the main menu, the user clicks on the quick bureau button and is taken to the bureau pages. In step 458, if the user pulls the credit bureau report on a consumer applicant, then the user proceeds to enter the consumer applicant information in step 460. The quick bureau page defaults to the consumer section and does not require selection if a consumer credit bureau is being pulled. In step 462, once the data entry is complete, the user selects the credit bureau provider they wish to use and clicks the get reports button. In step 458, if the user pulls the credit bureau report on a commercial applicant, then the user selects the commercial tab to enter the commercial bureau section in step 464. In step 466, the user proceeds with entering the commercial applicant information. The quick bureau continues to step 462. In step 468, if all required data been has not been entered properly and fully in order to successfully pull a credit bureau, then a notification will be displayed in step 470 indicating the information required and corrections are made by the user. The quick bureau returns to step 468. In step 468, if all required data been has been entered properly and fully in order to successfully pull a credit bureau, then the credit bureau is pulled and stored for a specific period of time as per privacy laws in step 472. Once pulled, the bureau is accessible only by the individual who pulled the report to ensure that privacy laws are upheld and the security of the credit bureau is maintained. In step 474, a folder is created using the entered information and the user is taken to a page where details can be entered to start a folder. In step 476, if the user does not want to make use of the folder that was started with the information enter from the quick bureau process, then the user discards the information and leaves the page in step 478. The data remains in the folder with the bureau that was pulled. In step 476, if the user does want to make use of the folder that was started with the information enter from the quick bureau process, then the process continues to step 432.

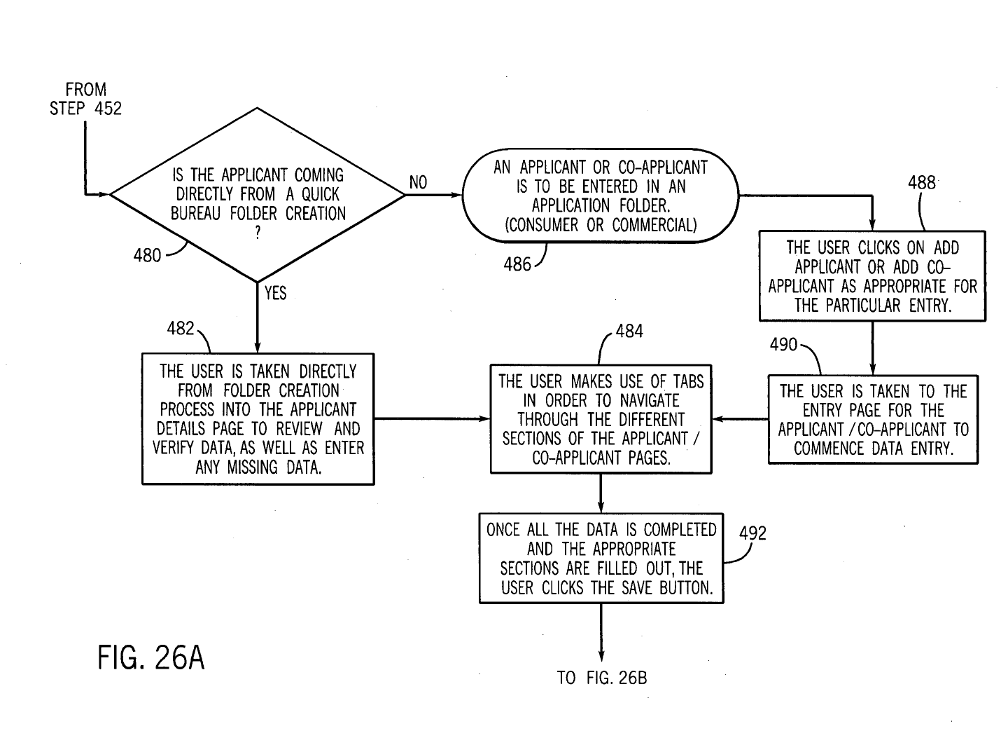

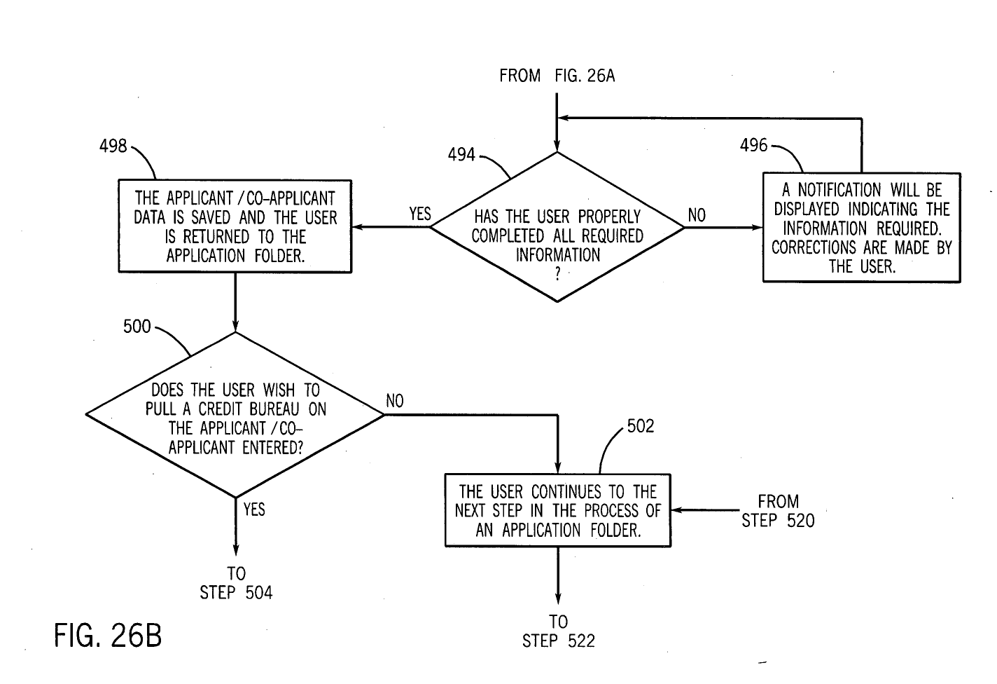

A flowchart of the applicant/co-applicant entry process is shown in FIGS. 26a-26b. In step 480, if the applicant is coming directly from a quick bureau folder creation, then the user is taken directly from folder creation process into the applicant details page to review and verify data, as well as enter any missing data in step 482. If the applicant is being carried over from a quick bureau folder creation, some of the data is already present. The applicant entry process continues to step 484. In step 480, if the applicant is not coming directly from a quick bureau folder creation, then an applicant or co-applicant is entered in an application folder as consumer or commercial applicant in step 486. In step 488, the user clicks on add applicant or add co-applicant as appropriate for the particular entry. In step 490, the user is taken to the entry page for the applicant/co-applicant to commence data entry. In step 484, the user makes use of tabs in order to navigate through the different sections of the applicant/co-applicant pages. In step 492, once all data is completed and the appropriate sections are filled out, the user clicks the save button. In step 494, if the user has not properly completed all required information, then a notification will be displayed in step 496 indicating the information required. Corrections are made by the user. In step 494, if the user has properly completed all required information, then the applicant/co-applicant data is saved and the user is returned to the application folder in step 498. The host system incorporates lender-specific rules to ensure the data that is sent is complete and accurate. If a lender rule is broken, the user will be informed and correction will have to be made in order to save successfully. The verification also includes simple formatting checks for phone numbers, SSN, numeric fields, etc. In step 500, if the user pulls a credit bureau report on the applicant/co-applicant, then the applicant entry process continues to step 504. Once applicant/co-applicant data has been entered and validated, the user has an option to pull a credit bureau on the individual/business entered. In step 500, if the user does not pull a credit bureau report on the applicant/co-applicant, then the user continues to the next step in the process of an application folder in step 502. The process continues to step 522.

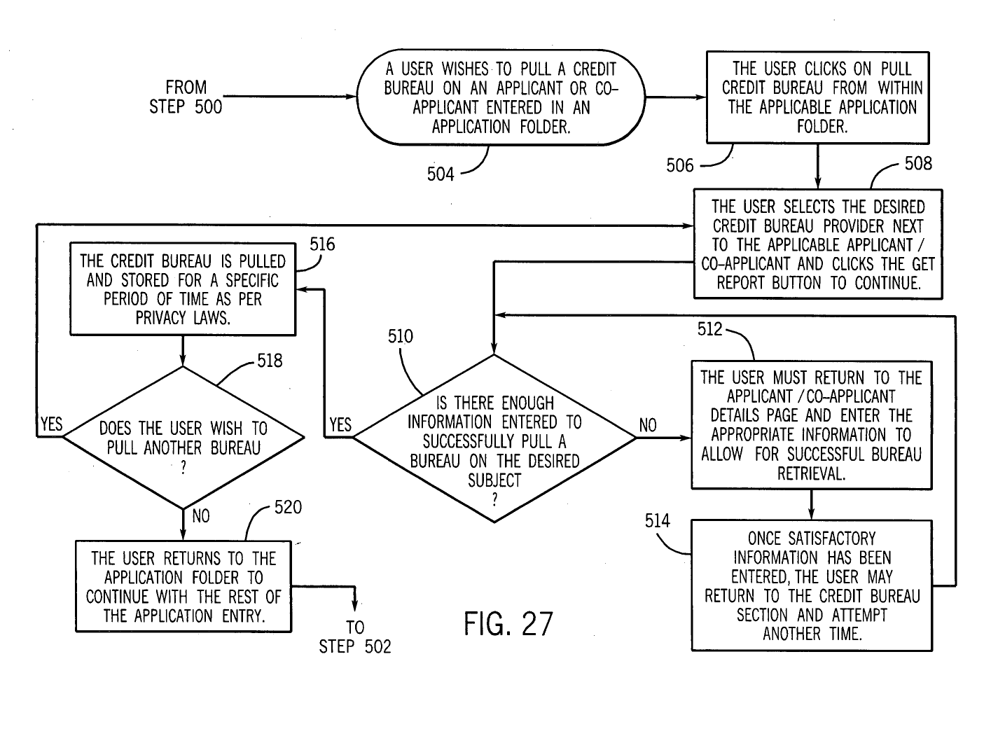

A flowchart of the credit bureau process is shown in FIG. 27. In step 504, a user pulls a credit bureau report on the applicant or co-applicant entered in an application folder. In step 506, the user clicks on pull credit bureau from within the applicable application folder. In step 508, the user selects the desired credit bureau provider next to the applicable applicant/co-applicant and clicks the get report button to continue. In step 510, if there is not enough information entered to successfully pull a bureau on the desired subject, then the user must return to the applicant/co-applicant details page and enter the appropriate information to allow for successful bureau retrieval in step 512. In step 514, once satisfactory information has been entered, the user may return to the credit bureau section and attempt another time. The credit bureau process returns to step 510. In step 510, if there is enough information entered to successfully pull a bureau on the desired subject, then the credit bureau is pulled and stored for a specific period of time as per privacy laws in step 516. Once pulled, the bureau is accessible only by the individual who pulled the report to ensure that privacy laws are upheld and the security of the bureau is maintained. In step 518, if the user wants to pull another credit bureau report, then the credit bureau process returns to step 508. In step 518, if the user does not want to pull another credit bureau report, then the user returns to the application folder to continue with the rest of the application entry in step 520. The process continues to step 502.

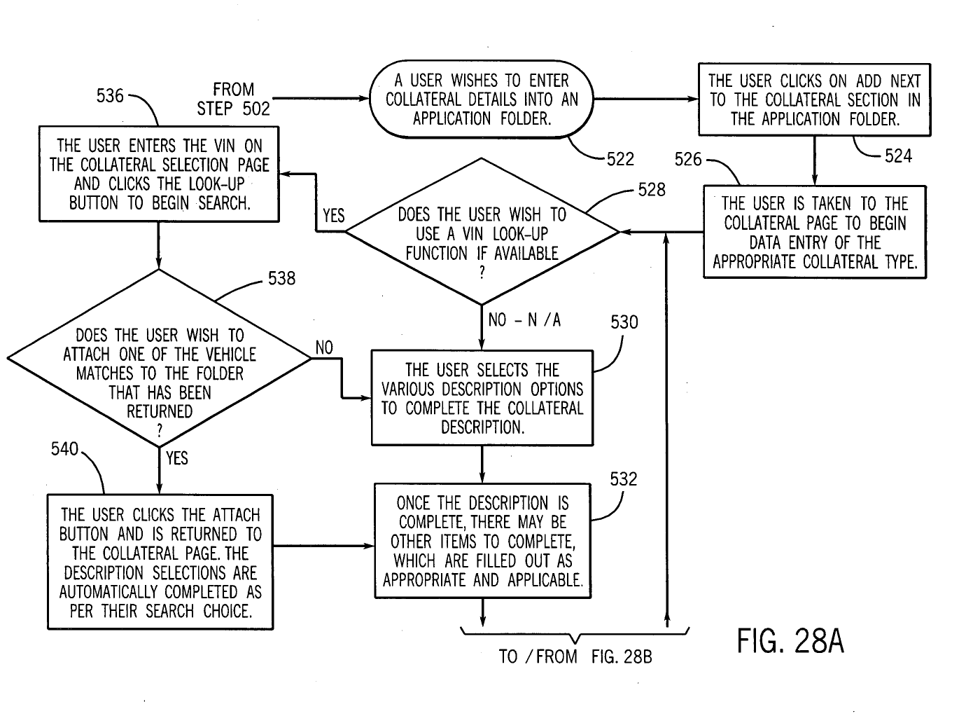

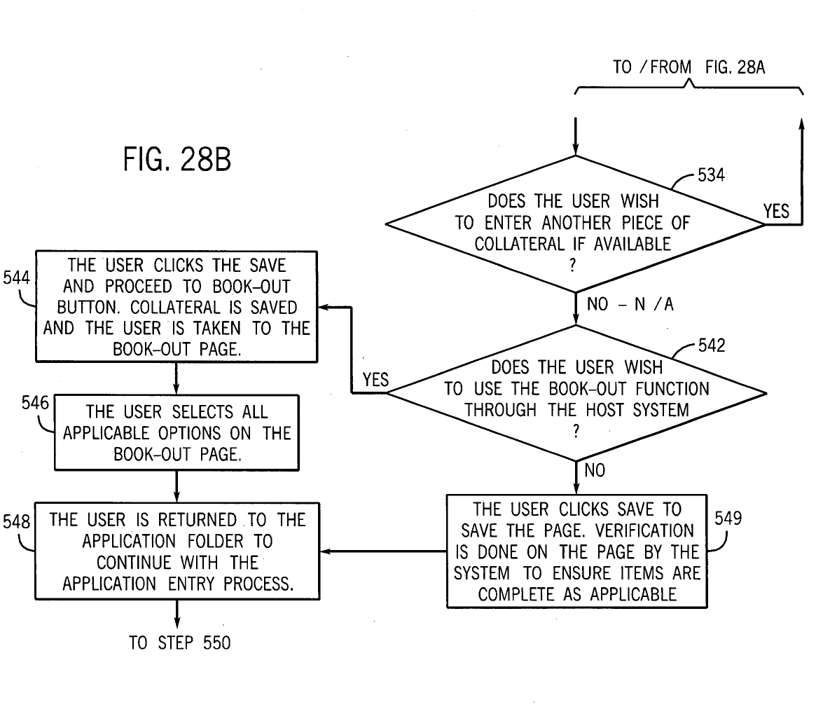

A flowchart of the credit bureau process is shown in FIGS. 28a-28b. In step 522, a user enters collateral details into an application folder. In step 524, the user clicks on add next to the collateral section in the application folder. In step 526, the user is taken to the collateral page to begin data entry of the appropriate collateral type. The collateral page that is used in an application folder is based on the collateral type that was chosen during application creation. Each collateral selection page is customized for the particular collateral type, e.g., automotive, RVs, horse trailer, marine, and power sports. In step 528, if the user does not use a vehicle identification number (VIN) look-up function, then the user selects the various description options to complete the collateral description in step 530. The collateral description may include items such as year, make, model, series, body style, class, type, etc. In step 532, once the description is complete, there may be other items to complete, which are filled out as appropriate and applicable. The other items may include odometer, hours, length, residual provider, value, etc. These items are built to be lender specific in order to ensure a lender is getting all required information to successfully approve an application. In step 534, if the user wants to enter another piece of collateral, then the collateral entry process returns to step 528. On certain collateral pages, multiple items are selectable, e.g., boat, engine, and trailer. In step 528, if the user does use a VIN look-up function, then the user enters the VIN on the collateral selection page and clicks the look-up button to begin search in step 536. Specifically in the automotive collateral entry page, the user has an option to enter the VIN of the vehicle being purchased and perform a search of the host database. The database will return a matching vehicle or vehicles for the specific VIN and the user can attach that vehicle to the application, which saves the user time of entry. In step 538, if the user does not attach one of the vehicle matches to the folder that has been returned, then the collateral entry process returns to step 530. In step 538, if the user does attach one of the vehicle matches to the folder that has been returned, then the user clicks the attach button and is returned to the collateral page in step 540. The description selections are automatically completed as per their search choice. The collateral entry process returns to step 532. In step 534, if the user does not want to enter another piece of collateral, then the system checks to see if the user wants to use the book-out function in step 542. Book-out is used to select various “add-ons” relating to the selected collateral. The add-ons are sometimes needed by the lender to justify a higher value for the collateral. If the user wants to use the book-out function, then the user clicks the save and proceed to book-out button in step 544. Collateral is saved and the user is taken to the book-out page. The host may have specific rules in each collateral page that indicate which fields are required for a successful save. The rules can be based on host standards, as well as lender rules, to ensure clean submissions. In step 546, the user selects all applicable options on the book-out page. In step 548, the user is retuned to the application folder to continue the application entry process. The process continues to step 550. In step 542, if the user does not want to use the book-out function, then the user saves the page in step 549. Verification is done on the page by the system to ensure items are complete as applicable. The process continues to step 548.

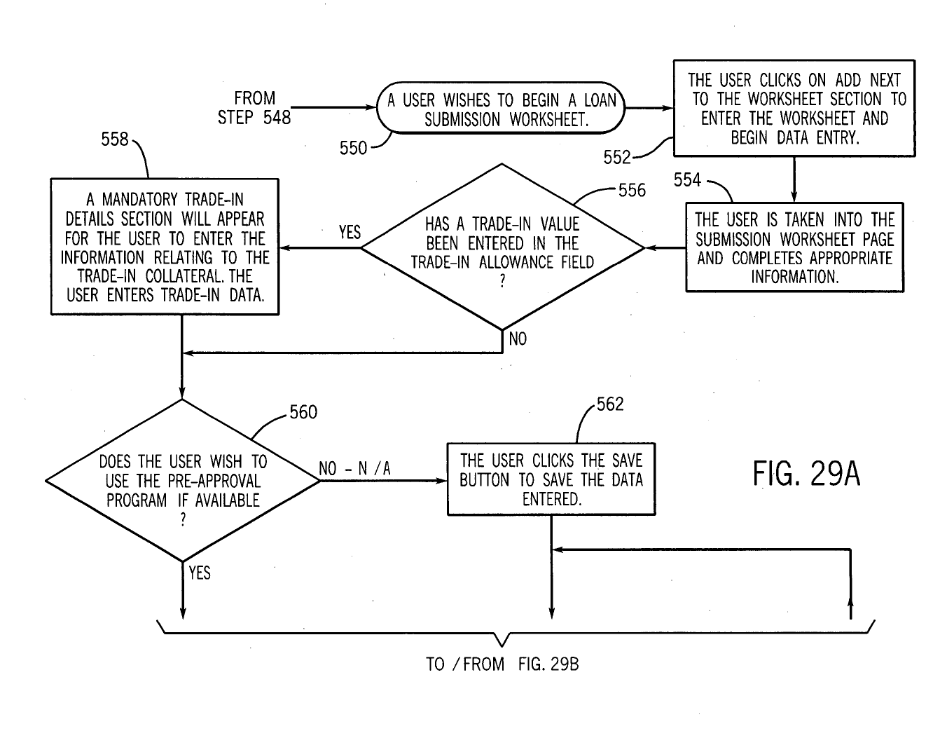

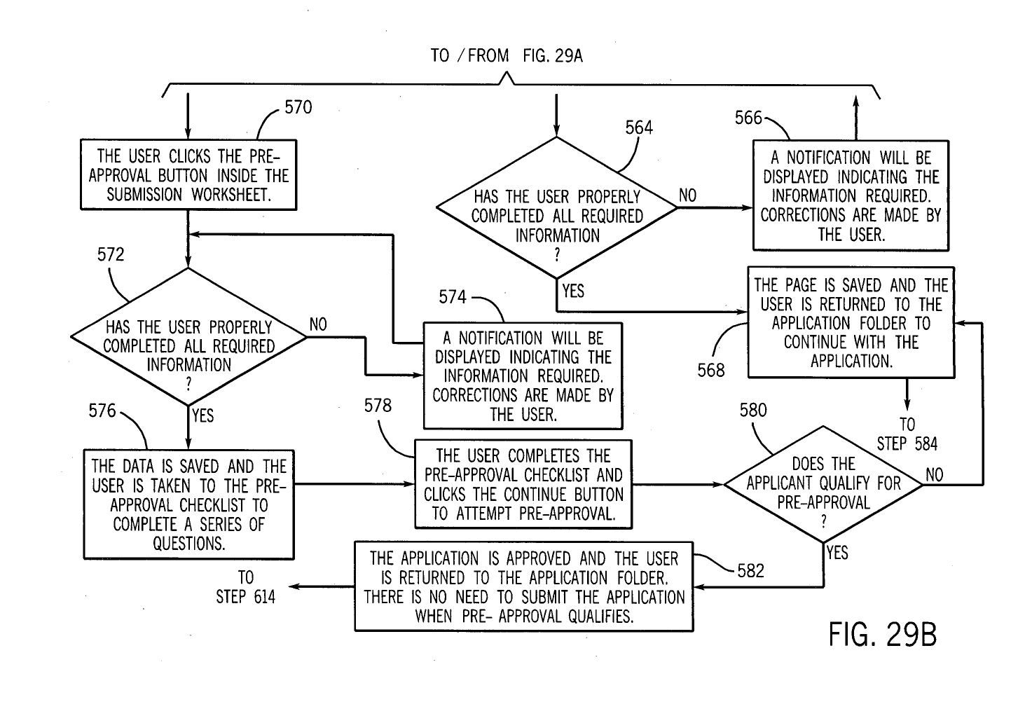

A flowchart of the loan submission worksheet process is shown in FIGS. 29a-29b. In step 550, a user begins a loan submission worksheet. In step 552, the user clicks on add button on the worksheet section to enter the worksheet and begin data entry. In step 554, the user is taken into the submission worksheet page and completes appropriate information. The submission worksheet is a preliminary worksheet with limited detail. The user will be required to specify items such as cash selling price, interest rate, term, etc. Also, optional information such as cash down and trade-in data. In step 556, if a trade-in value has been entered in the trade-in allowance field, then a mandatory trade-in details section will appear for the user to enter the information relating to the trade-in collateral in step 558. The user enters trade-in data. The submission worksheet process continues to step 560. In step 556, if a trade-in value has not been entered in the trade-in allowance field, then the submission worksheet process continues to step 560. In step 560, if the user does not use the pre-approval program, then the user clicks the save button to save the data entered in step 562. In step 564, if the user has not properly completed all required information, then a notification will be displayed indicating the information required in step 566. Corrections are made by the user. The submission worksheet process returns to step 564. In step 564, if the user has properly completed all required information, then the page is saved and the user is returned to the application folder to continue with the application in step 568. The process continues to step 584. In step 560, if the user does use the pre-approval program, then the user clicks the pre-approval button inside the submission worksheet in step 570. The host system incorporates a lender's pre-approval program into the host system. A dealer can receive a pre-approval on an application completely based on lender rules and restrictions through the host. This is optional for the user but to use this function a credit bureau must be pulled. In step 572, if the user has not properly completed all required information, then a notification will be displayed indicating the information required in step 574. Corrections are made by the user. The submission worksheet process returns to step 572. In step 572, if the user has properly completed all required information, then the data is saved and the user is taken to the pre-approval checklist to complete a series of questions in step 576. In step 578, the user completes the pre-approval checklist and clicks the continue button to attempt pre-approval. In step 580, if the applicant does not qualify for pre-approval, then the submission worksheet process returns to step 568. In step 580, if the applicant does qualify for pre-approval, then the application is approved and the user is returned to the application folder in step 582. In some cases, there is no need to submit the application when pre-approval qualifies. The process continues to step 614.

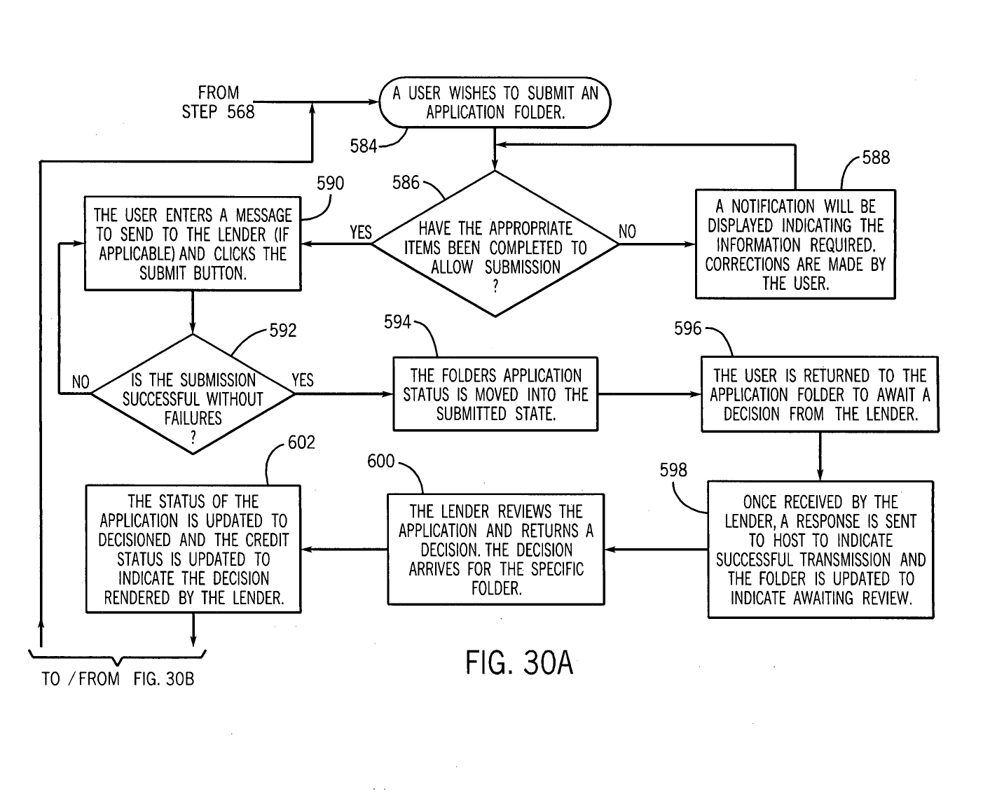

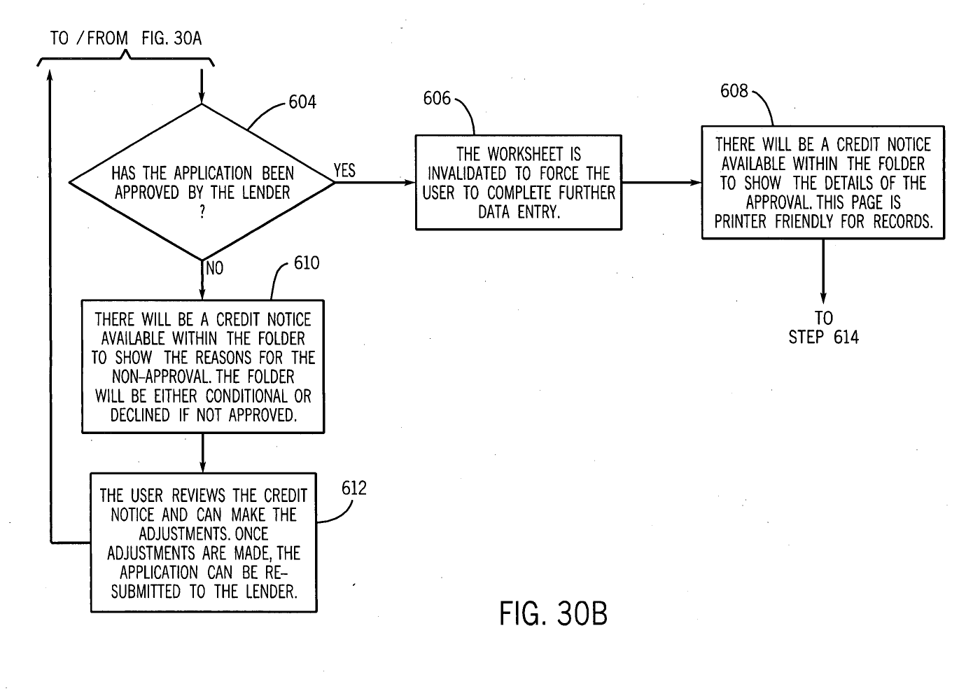

A flowchart of the application submission and decision process is shown in FIGS. 30a-30b. In step 584, a user submits an application folder. In step 586, if the appropriate items have not been completed to allow submission, then a notification will be displayed indicating the information required in step 588. Corrections are made by the user. The application submission process returns to step 586. In step 586, if the appropriate items have been completed to allow submission, then the user enters a message to send to the lender and clicks the submit button in step 590. There are specific items in each application folder that need to be complete and validated before submission will be allowed. These items are specific for each lender and are incorporated by the host based on lender requirements. If items have not been completed appropriately, there will be no submit button available. In step 592, the application submission process has not been successful, then the process returns to step 590. In step 592, the application submission process has been successful without failures, then the folder application status is moved into the submitted state in step 594. There are reasons for failed submissions, such as data problems or connectivity errors. Should one of these issues occur, the user will be notified and can contact the host support team. In step 596, the user is returned to the application folder to await a decision from the lender. In step 598, once received by the lender, a response is sent to the host to indicate successful transmission and the folder is updated to indicate awaiting review. In step 600, the lender reviews the application and returns a decision. The decision arrives for the specific folder. In step 602, the status of the application is updated to a decision'ed status and the credit status is updated to indicate the decision rendered by the lender. In step 604, if the application has been approved by the lender, then the worksheet is invalidated to force the user to complete further data entry in step 606. In order to complete a full approved application, the user must complete the contract worksheet. The detailed contract worksheet adds more structure and options to the submission worksheet. When the user enters the application folder of an approved application for the first time, the worksheet is invalidated to force entry before printing contracts. The documentation section cannot be accessed until the contract worksheet is complete and validated. In step 608, there will be a credit notice available within the folder to show the details of the approval. This page is printer friendly for records. The process continues to step 614. In step 604, if the application has not been approved by the lender, then there will be a credit notice available within the folder to show the reasons for the non-approval in step 610. The folder will be either conditional or declined if not approved. In step 612, the user reviews the credit notice and can make the adjustments. Once adjustments are made, the application can be re-submitted to the lender. The application submission process returns to step 584.

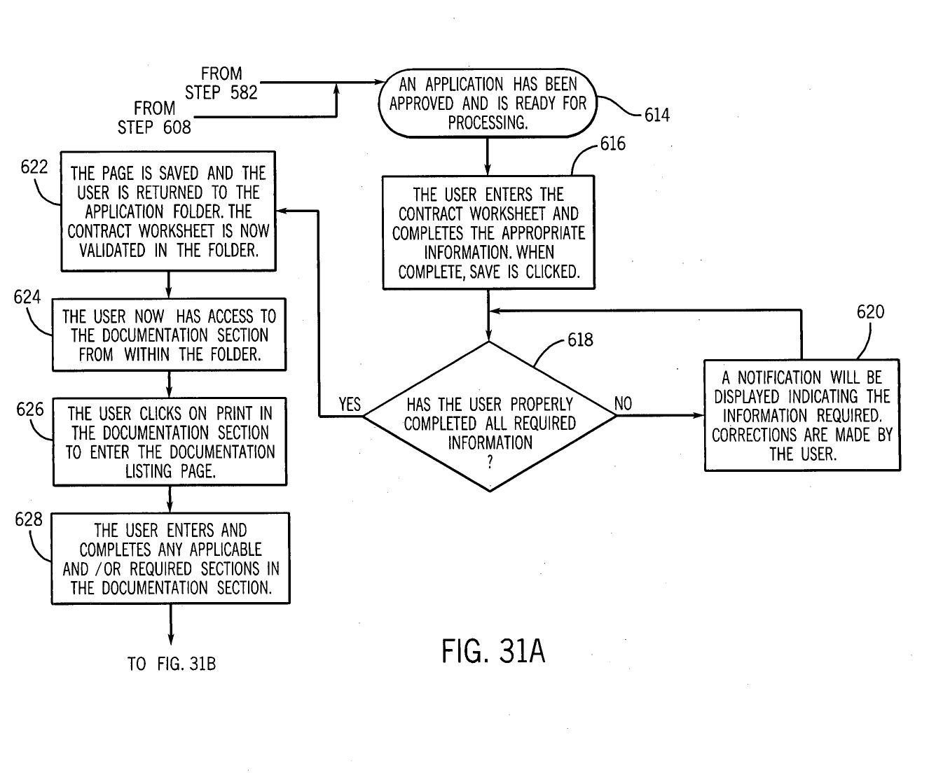

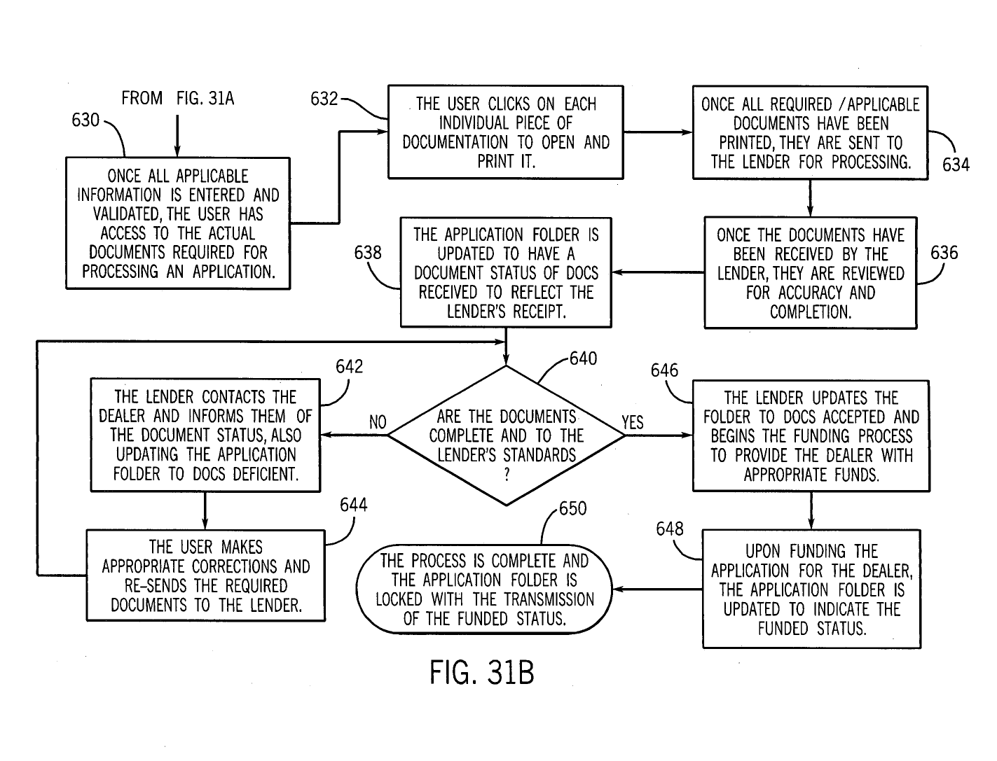

A flowchart of the approval process after the application has been approved is shown in FIGS. 31a-31b. In step 614, an application has been approved and is ready for processing. In step 616, the user enters the contract worksheet and completes the appropriate information. When complete, the save button is clicked. The contract worksheet is built dynamically depending on lender, state, and the specific details of the application. The rules and restrictions in the contract worksheet are lender specific and can be customized for very specific parameters to meet documentation requirements. In step 618, if the user has not properly completed all required information, then a notification will be displayed indicating the information required in step 620. Corrections are made by the user. The approval process returns to step 618. In step 618, if the user has properly completed all required information, then the page is saved and the user is returned to the application folder in step 622. The contract worksheet is now validated in the application folder. In step 624, the user now has access to the documentation section from within the application folder. In step 626, the user clicks on the print button in the documentation section to enter the documentation listing page. In step 628, the user enters and completes any applicable and/or required sections in the documentation section. The documentation section is built specific for each lender. The host system integrates lender requirements into this section to ensure all document requirements are met and each contract that is delivered to the bank through the host is clean and complete. In step 630, once all applicable information is entered and validated, the user has access to the actual documents required for processing an application. In step 632, the user clicks on each individual piece of documentation to open and print it. The host system uses the data entered earlier in the application process to populate the documentation as per lender requirements. Documents are either from a third party provider specializing in indirect financing, or if a lender chooses, the host will populate and make available the lender's own documents. In step 634, once all required/applicable documents have been printed, they are sent to the lender for processing. In step 636, once the documents have been received by the lender, they are reviewed for accuracy and completion. In step 638, the application folder is updated to have a status of documents received to reflect the lender's receipt. In step 640, if the documents are not complete to the lender's standards, then the lender contacts the dealer and informs them of the document status, also updating the application folder to docs deficient in step 642. In step 644, the user makes appropriate corrections and re-sends the required documents to the lender. The application approved process returns to step 640. In step 640, if the documents are complete to the lender's standards, then the lender updates the folder to docs accepted and begins the funding process to provide the dealer with appropriate funds in step 646. In step 648, upon funding the application for the dealer, the application folder is updated to indicate the funded status. In step 650, the process is complete and the application folder is locked with the transmission of the funded status.

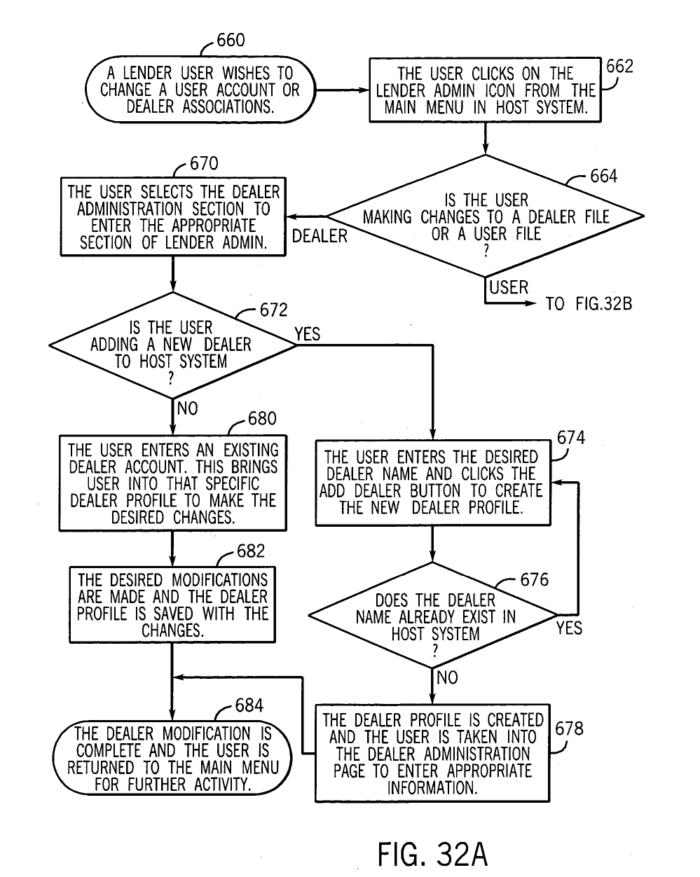

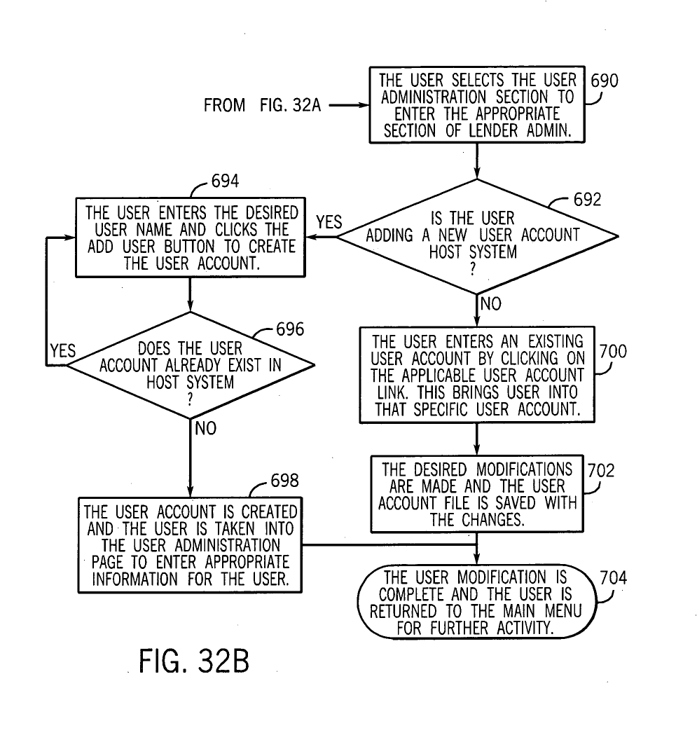

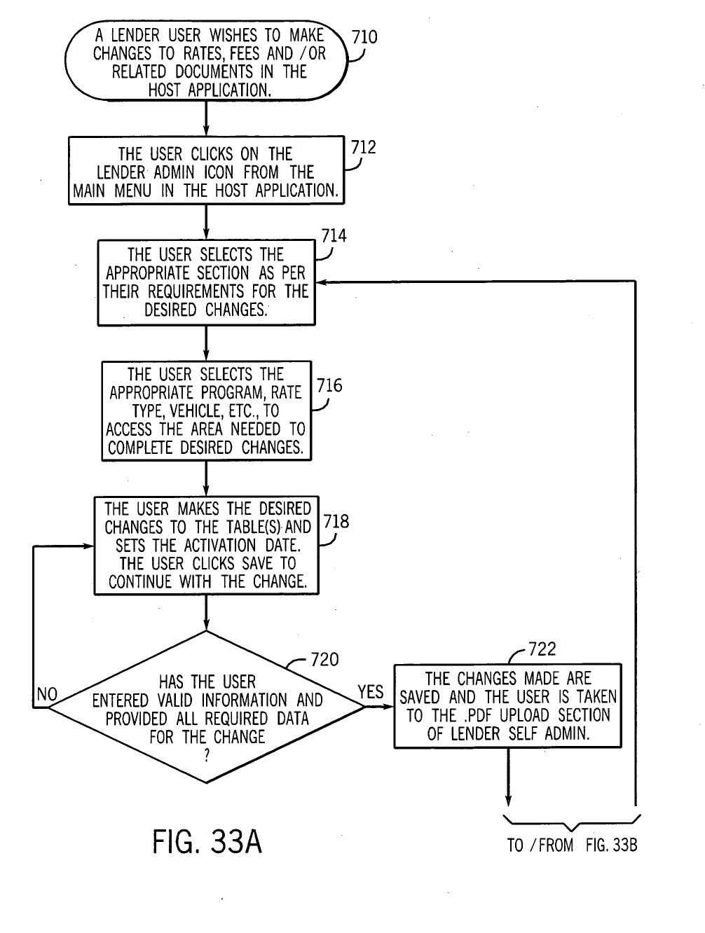

A flowchart of the lender self administration for users and dealers is shown in FIGS. 32a-32b. In step 660, a lender may want to change a user account or dealer association. In step 662, the user clicks on the lender admin icon from the main menu of the host system. Access to lender admin is based on the permission group. If a user is not assigned to the appropriate permission group, they will not have access to lender admin. In step 664, the system checks to see if the lender is making changes to a dealer file or user file. If the lender is making changes to a dealer file, then the lender selects the dealer administration section to enter the appropriate section of lender admin in step 670. In step 672, if the lender is adding a new dealer to the host system, then the lender enters the dealer name and clicks the add dealer button to create the new dealer profile in step 674. In step 676, if the dealer name is already in the host system, then the process return to step 674. If the dealer name is not already in the host system, then the dealer account and profile is created and the lender is taken into the dealer administration page to enter appropriate information in step 678. In step 672, if the lender is not adding a new dealer to the host system, then the lender enters an existing dealer account by clicking on the applicable dealer account link to bring up the dealer account profile and make the necessary changes in step 680. In step 682, the desired modifications are made and the dealer profile is saved with the changes. In step 684, the dealer modification is complete and the lender returns to the main menu for further activity.

In step 664, if the lender is making changes to a user file, then the lender selects the user administration section to enter the appropriate section of lender admin in step 690. In step 692, if the lender is adding a new user to the host system, then the lender enters the user name and clicks the add user button to create the new user account profile in step 694. In step 696, if the user name is already in the host system, then the process return to step 694. If the user name is not already in the host system, then the user account and profile is created and the lender is taken into the user administration page to enter appropriate information in step 698. In step 692, if the lender is not adding a new user to the host system, then the lender enters an existing user account by clicking on the applicable user account link to bring up the user profile and make the necessary changes in step 700. In step 702, the desired modifications are made and the user account profile is saved with the changes. In step 704, the user modification is complete and the lender returns to the main menu for further activity.

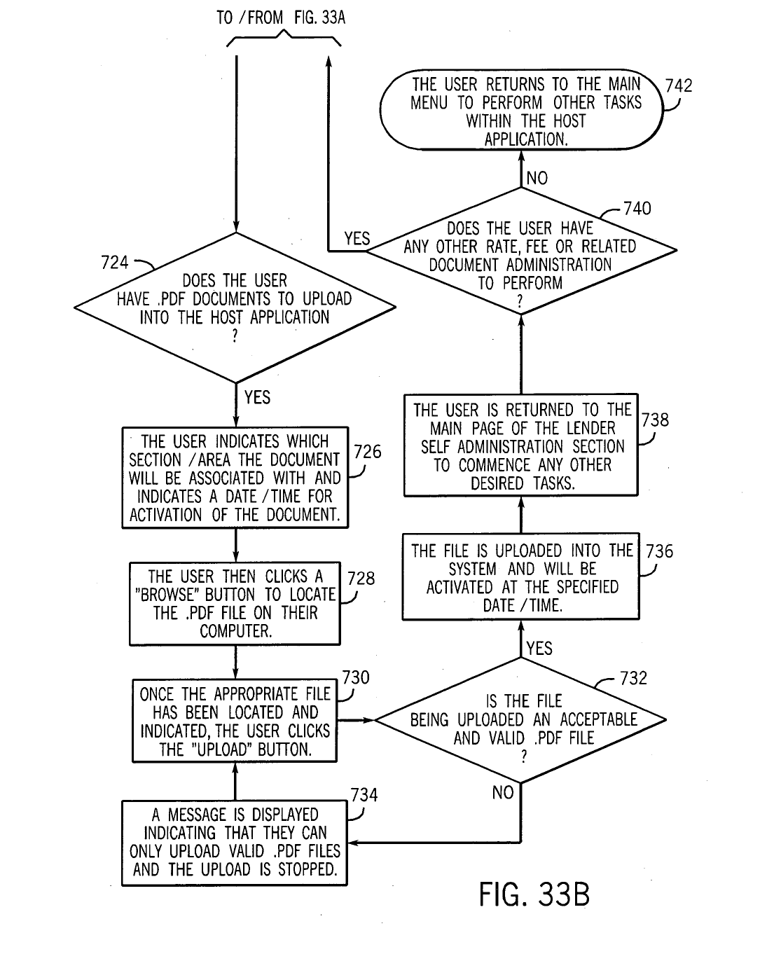

A flowchart of the lender self administration for table and document management is shown in FIGS. 33a-33b. In step 710, a lender may want to make changes to rates, fees, and related documents in the host application. In step 712, the user clicks on the lender admin icon from the main menu of the host system. Access to lender admin is based on the permission group. If a user is not assigned to the appropriate permission group, they will not have access to lender admin. In step 714, the lender selects the appropriate section as per their requirements for the desired changes. In step 716, the lender selects the appropriate program, rate, type, vehicle, etc. to access the area needed to complete the desired changes. In step 718, the lender makes the desired changes to the tables and sets the activation date. The lender clicks save to continue with the change. In step 720, if the lender has not entered valid information and provided all required data for the change, then the process returns to step 718. If the lender has entered valid information and provided all required data for the change, then the changes are saved and the lender is taken to the .pdf upload section of lender self admin in step 722. In step 724, if the lender has a .pdf document to upload into the host application, then the user indicates which section or area the document will be associated and indicates date and time for activation of the document in step 726. In step 728, the lender clicks a browse button to locate the .pdf file. In step 730, once the appropriate file has been located and indicated, the lender clicks the upload button. In step 732 if the file being uploaded is not an acceptable and valid .pdf file, then a message is displayed indicating the problem in step 734. The upload is stopped and the process returns to step 730. The host system has various security measures in place to ensure that harmful content cannot be uploaded into the system. If the file selection is not a .pdf file, the upload will not be allowed. The check is performed not only on the file extension itself, but also on a specific file identifier present in .pdf files that confirms file validity and integrity. In step 732, if the file being uploaded is an acceptable and valid .pdf file, then the file is uploaded into the system and will be activated at the specified date and time in step 736. In step 738, the lender is returned to the main page of the lender self administration section to commence any other desired tasks. In step 740, if the lender has any other rate, fee, or related document administration to perform, then the process returns to step 714. Otherwise, the lender returns to the main menu to perform other tasks in the host application in step 742.

In summary, the computer implemented asset financing system is provided by the host service provider for the benefit of the dealer, lender, and consumer alike. The asset financing system is dynamically customized to support each lender's requirements in displaying the appropriate fields, validating customer loan data, and generating the documentation for the single selected lender. The dealer only has to address the loan information that is relevant and important for the selected lender. Dealers and lenders can provide the optimized service and support for customers and thereby distinguish themselves in the market for major asset financing. The lender-specific data entry, document generation, and approval process help facilitate the rapid and effective approval of asset financing transactions.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer implemented method of processing asset financing transactions, comprising:
providing for selection of a single financial institution to receive a financing package;
providing a plurality of data entry screens configured to requirements of the single financial institution for entry of financing information; and
compiling the financing package from the financing information for submission to the single financial institution.

2. The computer implemented method of claim 1, wherein the asset financing transaction is a loan or lease.

3. The computer implemented method of claim 1, further including providing for pre-approval of the financing package prior to submission to the single financial institution.

4. The computer implemented method of claim 1, wherein the single financial institution is selected based on the financing information and knowledge and prior experience attributed to the single financial institution.

5. The computer implemented method of claim 1, wherein one of the plurality of data entry screens is configurable to accommodate multiple forms of collateral.

6. The computer implemented method of claim 1, further including validating the financing information entered into at least one field of the plurality of data entry screens based on the requirements of the single financial institution.

7. The computer implemented method of claim 1, further including electronically transmitting the financing package to the single financial institution.

8. The computer implemented method of claim 1, further including:
providing for request of status of financing applications based on search criteria; and
providing a status list of the financing applications.

9. The computer implemented method of claim 1, further including:
providing for request of a credit report of an applicant;
receiving the credit report of the applicant; and
populating at least one field of the plurality of data entry screens with applicant information from the credit report.

10. The computer implemented method of claim 1, further including:
sending an electronic message to the single financial institution; and
receiving an electronic message from the single financial institution.

11. The computer implemented method of claim 1, further including providing a forum for communication with the single financial institution.

12. A method of processing asset financing transactions through a dealer, comprising:
providing for selection of a single lender to receive a financing package;
providing a data entry screen for entering financing information into fields of the data entry screen;
compiling the financing package from the financing information entered into the fields of the data entry screen; and
providing for pre-approval of the loan package prior to submission to the single lender.

13. The method of claim 12, wherein the data entry screen is configurable to receive multiple types of collateral information.

14. The method of claim 12, wherein the data entry screen is configurable to receive loan financing information based on requirements of the single lender.

15. The method of claim 12, further including:
providing for request of status of financing applications based on search criteria; and
providing a status list of the financing applications.

16. The method of claim 12, further including:
providing for request of a credit report of an applicant;
receiving the credit report of the applicant; and
populating at least one field of the data entry screen with applicant information from the credit report.

17. The method of claim 12, further including:
sending an electronic message to the single lender; and
receiving an electronic message from the single lender.

18. The method of claim 12, further including providing a forum for communication with the single lender.

19. A method of processing asset financing transactions, comprising:
providing a process for receiving financing information related to financing of an asset;
providing for selection of a single financial institution to receive a financing package compiled from the financing information; and
transmitting the financing package to the single financial institution.

20. The method of claim 19, further including providing for pre-approval of the financial institution package prior to submission to the single financial institution.

21. The method of claim 19, wherein the single financial institution is selected based on the financing information and knowledge and prior experience attributed to the single financial institution.

22. The method of claim 19, further including providing a data entry screen configurable to receive multiple forms of collateral information.

23. The method of claim 19, further including providing a data entry screen configurable to receive financing information based on requirements of the single financial institution.

24. The method of claim 19, further including validating the financing information based on requirements of the single financial institution.

25. The method of claim 19, further including electronically transmitting the financing information to the single financial institution.

26. The method of claim 19, further including:
providing for request of status of financing applications based on search criteria; and
providing a status list of the financing applications.

27. The method of claim 19, further including:
providing for request of a credit report of an applicant;
receiving the credit report of the applicant; and
populating at least one field of a data entry screen with applicant information from the credit report.

28. A method of processing asset financing transactions, comprising:
providing a process for receiving loan information related to financing of an asset, wherein the process includes a data entry screen configurable to receive multiple forms of collateral information;
providing for selection of a single financial institution to receive a financing package compiled from the financing information; and
transmitting the financing package to the single financial institution.

29. A computer program product usable with a programmable computer processor having a computer readable program code embodied therein, comprising:
computer readable program code which receives financing information related to financing of an asset;
computer readable program code which provides for selection of a single financial institution to receive a financing package;
computer readable program code which provides for entry of financing information into fields of a data entry screen; and
computer readable program code which compiles the financing package from the financing information for submission to the single financial institution.

30. The computer program product of claim 29, wherein the data entry screen is configurable to receive multiple forms of collateral information.

31. The computer program product of claim 29, wherein the data entry screen is configurable to receive financing information based on requirements of the single financial institution.

32. A computer system for processing asset financing transactions, comprising:
means for receiving loan information related to financing of an asset;
means for selecting a single lender to receive a loan package;
means for providing a data entry screen for entering the loan information into fields of the data entry screen; and
means for compiling the loan package from the loan information for submission to the single lender.

33. The computer system of claim 32, wherein the data entry screen is configurable to receive multiple forms of collateral information.

34. The computer system of claim 32, wherein the data entry screen is configurable to receive loan financing information based on requirements of the single lender.
